(19) United States
(12) Patent Application Publication
(10) Pub. No.: US 2017/0051933 A1
(43) Pub. Date: Feb. 23, 2017

(54) PERSISTENT HOME THERMAL COMFORT MODEL REUSABLE ACROSS MULTIPLE SENSOR AND DEVICE CONFIGURATIONS IN A SMART HOME

(71) Applicant: Google Inc., Mountain View, CA (US)

(72) Inventors: Pieter Verhoeven, San Francisco, CA (US); Todd Hester, San Francisco, CA (US)

(21) Appl. No.: 14/832,675

(22) Filed: Aug. 21, 2015

(51) Int. Cl. F24F 11/00; G05B 15/02

(52) U.S. Cl. CPC F24F 11/006; G05B 15/02

(57) ABSTRACT

This patent specification relates to systems and methods for modeling characteristics of an enclosure. More particularly, this patent specification relates to thermal modeling of internal temperature dynamics of the enclosure.

### TECHNICAL FIELD

This patent specification relates to systems and methods for modeling characteristics of an enclosure. More particularly, this patent specification relates to thermal modeling of internal temperature dynamics of the enclosure.

### BACKGROUND

Substantial effort has been put forth on the development of new and more sustainable energy supplies, as well as efforts to increase energy efficiency of existing energy consumption systems. An example of an energy consumption system is the heating and cooling system of an enclosure such as a home or building. Heating and cooling can account for a large percentage of the energy use in a typical home, making it a significant energy expense. Heating and cooling systems can realize greater efficiency by improving physical aspects of the system (e.g., higher efficiency furnace) and enclosure (e.g., more or better insulation). Substantial increases in energy efficiency can also be achieved through enhanced thermostat control of the heating and cooling system.

To manage a thermal environment of a structure such as a residential or commercial building, one or more HVAC control systems are typically used. HVAC control systems need to make decisions as to how to condition the enclosure appropriately, which may include varying an internal heat, humidity, or other environmental characteristic. Since the enclosure has an associated thermal mass that needs to be heated or cooled, how and when the heating or cooling is carried out can greatly impact the energy efficiency as well as the cost of the process.

Conventionally, a model that attempts to specify how a structure will behave under the influence of an HVAC system is created based on a variety of factors such as structure size, number and characteristics of windows included in the structure, etc. That model is then used to specify the type and size of HVAC system to install and/or it is used by the HVAC control system throughout the lifetime of the building. For example, U.S. Pat. No. 7,072,727 discusses a method for determining heat loss of a building and for the proper sizing of HVAC equipment for the building.

It is also known for model updates to occur after installation through simple calculations such as adding heat and measuring time and temperature. For example, U.S. Pat. No. 5,555,927 discusses an adapted recovery method for a setback thermostat using the intersection of the space temperature with a sloped recovery temperature line which approximates the change in temperature as a function of time during recovery of the temperature controlled space from the setback temperature, to determine the time at which recovery to the occupancy temperature should begin. The recovery line slope is re-calculated and updated.

U.S. Patent Application Publication No. 2005/0192915 discusses a system for forecasting predicted thermal loads for a building including a neural-network-based thermal load predictor. The neural network can be trained using building data, occupancy data and actual weather conditions. A thermal condition forecaster uses a simple regression model based on forecasted high and low temperatures for a specific locale and measured local temperature and humidity observations made immediately prior to the prediction.

Other thermostat control of heating and cooling systems have adopted use of thermal modeling for preconditioning or other optimal temperature control. Yet conventional thermal modeling suffers from many disadvantages. Some thermal models rely on data acquisition that takes place over a relatively long period of time, and whenever there is change in sensors or controllers the thermal models may need to be recomputed from scratch, thereby requiring data collection over that same relatively long period of time before pseudo accurate modeling can be provided. For example, if a new sensor is added to the enclosure, the model may have to entirely re-compute a second thermal model of the enclosure. This can be disadvantageous in that all the time used to learn the first thermal, which may have encompassed many seasons of the year, goes to waste. Accordingly, what are needed are thermal models that can quickly and accurately account for changes in sensors, configurations, and controllers while re-using previously learned thermal characteristics of the enclosure.

### SUMMARY

This patent specification relates to modeling characteristics of an enclosure, and more particularly, to thermal modeling of internal temperature dynamics of an enclosure. The modeling can be implemented in a thermal control system such as a smart thermostat and can be used by that thermostat to provide enhanced control of a heating, ventilation, and air conditioning (HVAC) system.

In one embodiment, device associated with an enclosure can include a sensor database that temporarily stores a batch of device inputs and measurements, an intermediate history database that stores a recursively update history object, the recursively updated history object comprising a historical collection of the device inputs and measurements, and control circuitry coupled to the databases. The control circuitry is operative to execute a state-space model engine that approximates a thermodynamic state of the enclosure and generates at least one predicted output associated with the enclosure based on an evaluation of a state-space model comprising a plurality of vectors and a plurality of mapping functions, wherein each mapping function is associated with a respective one of the vectors. The control circuitry is operative to execute a mapping function determination engine that updates the plurality of mapping functions based on the batch of device inputs and measurements and the recursively updated history object.

In another embodiment, a method for modeling characteristics of an enclosure is provided. The method includes sampling inputs and measurements from at least one device at a first periodic basis to obtain a batch of the samplings, maintaining a recursively updated history object comprising a factorized historical collection of sampled inputs and measurements, representing thermal characteristics of the enclosure with a state-space model, generating at least one predicted output associated with the enclosure based on the state-space model, and updating the state-space model on a second periodic basis based on the batch of the samplings and the recursively updated history object, wherein the second periodic basis is less than the first periodic basis.

In yet another embodiment, a method for using a thermodynamic state-space model of an enclosure, the method implemented in a thermostat is provided. The method can temporarily storing data received from at least the thermostat, maintaining a recursively updated history object, the recursively updated history object comprising a historical collection of data that was previously temporarily stored, executing a state-space model engine that approximates a thermodynamic state of the enclosure and generates at least one predicted output associated with the enclosure based on an evaluation of a state-space model comprising a plurality of vectors and a plurality of mapping functions, wherein each mapping function is associated with a respective one of the vectors. The method includes executing a mapping function determination engine that updates the plurality of mapping functions based on the temporarily stored data and the recursively updated history object, and using the at least one predicted output to adjust a thermostat operation.

In yet another embodiment, a method for controlling a HVAC (heating, ventilation, and air conditioning) system based on a thermodynamic state-space model that characterizes thermal characteristics of an enclosure is provided. The method can include selecting an initial history object for use as a recursively updated history object, defining an initial set of parameters for use as a plurality of vectors represented in the state-space model, temporarily storing data received from at least one device associated with the enclosure, calculating at least one predicted output using the state-space model, and recursively updating the state-space model based on the plurality of vectors, the recursively updated history object, and the temporarily stored data.

In another embodiment, a thermostat for use in an enclosure is provided. The thermostat can include HVAC (heating, ventilation, and air conditioning) circuitry that controls HVAC states, a temperature sensor that measures an indoor temperature of the enclosure, and control circuitry operative. The control circuitry includes receive an outdoor temperature, access a thermodynamic state-space model engine that generates a predictive indoor temperature based, at least in part, on inputs that affect an internal temperature of the enclosure, at least one enclosure sensor reading, a current state-space model representation of the enclosure, and a correction factor that accounts for differences between the at least one predictive output and the at least one enclosure sensor reading, wherein the inputs comprise the HVAC states and the outdoor temperature, and wherein the at least one enclosure sensor reading comprises the indoor temperature.

In another embodiment, a method for controlling a HVAC (heating, ventilation, and air conditioning) system is provided. The method can be implemented in a thermostat, and can include defining a thermodynamic model that approximates thermal characteristics of an enclosure based on a set of inputs that affect thermal characteristics of the enclosure, a set of sensor readings that indicate observed thermal characteristics within the enclosure, and recursively updated history data. The method can include using the thermodynamic model to predict a set of outputs associated with the enclosure in response to application of the set of inputs, receiving an indication that a new sensor reading that indicates observed thermal characteristics within the enclosure is available, and in response to the received indication, incorporating the new sensor reading into the set of sensor readings so that the thermodynamic model is updated to take the new sensor reading into account.

In another embodiment, a method for using a state-space thermal model that approximates thermal characteristics of an enclosure based on a set of inputs that affect thermal characteristics of the enclosure, a set of sensor readings that indicate observed thermal characteristics within the enclosure, and recursively updated history data to identify unaccounted thermal sources is provided. The method can include generating a predicted temperature values for the enclosure using the state-space thermal model, obtaining actual temperature values existing within the enclosure, comparing the predicted temperature values to the actual temperature values to obtain delta values, determining whether one of the delta values exceeds a threshold, and if one of the delta values exceeds the threshold, determining whether to create a new input to account for presence of a new thermal source that is causing that threshold exceeding delta value to exist

In another embodiment, method for identifying a potential new thermal source within an enclosure is provided. The method can include executing a state-space model engine that approximates a thermodynamic state of the enclosure and generates at least one predicted output associated with the enclosure based on an evaluation of a state-space model comprising a plurality of vectors and a plurality of mapping functions, wherein each mapping function is associated with a respective one of the vectors, and monitoring a stability of a first mapping function to assess potential for existence of a thermal source that is not accounted for within a second one of the plurality of vectors. If the stability of the first mapping function is monitored to be unstable, comparing the at least one predicted output to an actual output to determine whether a delta between the comparison exceeds a threshold, and creating a new input that accounts for presence of the thermal source in the second vector if the delta between the comparison exceeds the threshold.

In another embodiment, a thermostat for use in an enclosure is provided. The thermostat can include HVAC (heating, ventilation, and air conditioning) circuitry that controls HVAC states, a temperature sensor that measures an indoor temperature of the enclosure, and control circuitry. The control circuitry can access a thermodynamic state-space model engine that generates a predictive indoor temperature based, at least in part, on inputs that affect an internal temperature of the enclosure, at least one enclosure sensor reading, and a current state-space model representation of the enclosure to identify a potential thermal source not accounted for in the inputs that affect an internal temperature of the enclosure.

A further understanding of the nature and advantages of the embodiments discussed herein may be realized by reference to the remaining portions of the specification and the drawings.

### BRIEF DESCRIPTION OF THE DRAWINGS

FIG. 1A illustrates an example of general device components which can be included in an intelligent, network-connected device that may be used to implement one or more of the thermodynamic behavior prediction processes, according to an embodiment;

FIG. 1B illustrates an intelligent, network-connected device having a replaceable module and a docking station for ease of installation, configuration, and upgrading according to an embodiment;

FIG. 2 is a diagram of an HVAC system, according to some embodiments;

FIG. 3 illustrates a network-level view of an extensible devices and services platform with which the smart home of FIGS. 1 and/or 2 can be integrated according to an embodiment;

FIG. 4 illustrates an abstracted functional view of the extensible devices and services platform of FIG. 3, with particular reference to the processing engine as well as the devices of the smart home environment, according to an embodiment;

FIG. 5 is a block diagram of a special-purpose computer system 500 according to an embodiment;

FIG. 6 illustrates components of an HVAC control system implementing a state space thermodynamic model according to an embodiment;

FIGS. 7A-7F shows different illustrative schematics showing different portions of the state-space model, according to some embodiments;

FIG. 8 shows an illustrative schematic representation of state-space model according to an embodiment;

FIG. 9 shows an illustrative schematic diagram illustrating mapping function determination engine of how mapping functions are updated, according to an embodiment;

FIG. 10 shows an illustrative flowchart for selecting an order for the state-space model according to an embodiment;

FIG. 11 shows different illustrative graphs showings model inputs, model outputs, and actual measured indoor temperature based on a test using the thermodynamic state-space model according to an embodiment;

FIG. 12 shows an illustrative process for modeling characteristics of an enclosure, according to an embodiment.

FIG. 13 shows an illustrative process for using a thermodynamic state-space model of an enclosure that is implemented in a thermostat, according to an embodiment;

FIG. 14 shows an illustrative process for controlling a HVAC system based on a thermodynamic state-space model that characterizes thermal characteristics of an enclosure, according to an embodiment;

FIG. 15 shows an illustrative process for controlling a HVAC system, according to an embodiment;

FIG. 16 shows a few illustrative graphs that illustrate how the thermal source detection process can determine whether a new thermal source exists.

FIG. 17 shows an illustrative process for detecting new thermal sources according to an embodiment.

### DETAILED DESCRIPTION OF THE INVENTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual embodiment, numerous embodiment-specific decisions may be required to achieve specific design objectives. These design objectives will vary from one embodiment to another and from one developer to another. Moreover, it will be appreciated that such a development effort might be complex and time-consuming but would nevertheless be a routine engineering undertaking for those of ordinary skill in the art having the benefit of this disclosure.

It is to be appreciated that while one or more embodiments are described further herein in the context of typical HVAC systems used in a residential home, such as single-family residential home, the scope of the present teachings is not so limited. More generally, thermostats according to one or more of the preferred embodiments are applicable for a wide variety of enclosures having one or more HVAC systems including, without limitation, duplexes, townhomes, multi-unit apartment buildings, hotels, retail stores, office buildings and industrial buildings. Further, it is to be appreciated that while the terms user, customer, installer, homeowner, occupant, guest, tenant, landlord, repair person, and the like may be used to refer to the person or persons who are interacting with the thermostat or other device or user interface in the context of one or more scenarios described herein, these references are by no means to be considered as limiting the scope of the present teachings with respect to the person or persons who are performing such actions.

Provided according to one or more embodiments are systems, methods, computer program products, and related business methods for controlling one or more HVAC systems based on one or more versatile sensing and control units (VSCU units), each VSCU unit being configured and adapted to provide sophisticated, customized, energy-saving HVAC control functionality while at the same time being visually appealing, non-intimidating, elegant to behold, and delightfully easy to use. The term “thermostat” is used hereinbelow to represent a particular type of VSCU unit (Versatile Sensing and Control) that is particularly applicable for HVAC control in an enclosure. Although “thermostat” and “VSCU unit” may be seen as generally interchangeable for the contexts of HVAC control of an enclosure, it is within the scope of the present teachings for each of the embodiments hereinabove and hereinbelow to be applied to VSCU units having control functionality over measurable characteristics other than temperature (e.g., pressure, flow rate, height, position, velocity, acceleration, capacity, power, loudness, brightness) for any of a variety of different control systems involving the governance of one or more measurable characteristics of one or more physical systems, and/or the governance of other energy or resource consuming systems such as water usage systems, air usage systems, systems involving the usage of other natural resources, and systems involving the usage of various other forms of energy.

Various methods, apparatus, systems, and computer-readable mediums are described herein that concern the field of thermodynamic behavioral modeling of structures. In many modern systems, including systems such include HVAC systems which manage the environmental characteristics in a structure, it is desirable to predict the thermodynamic behavior of a structure. Such predictions may have a variety of tangible, beneficial uses. In modern HVAC control systems, such predictions may be used on a daily basis to accurately actuate the HVAC system in reaching or maintaining desired setpoint temperatures. Such predictions may also be used periodically, such as during demand-response (DR) events, to more accurately identify a schedule of setpoint temperatures that maximizes the amount of energy shifted from the DR event period to a period of time outside of the DR event period, or a schedule that is optimal in some additional or alternative sense.

Regardless of the specific application in which predictions of thermodynamic behavior are implemented, such predictions in many embodiments are facilitated by the use of a thermodynamic model of the structure. The thermodynamic model itself may be defined by a state space model that characterizes the thermodynamic response of an enclosure, such as indoor temperature, in response to application of a stimulus, such as a change in HVAC actuation state and outdoor temperature. The state-space model is adaptable to incorporate actual measured data to update the model and is adaptable to incorporate new inputs and measured data points.

It should be recognized that the term “thermodynamic” may include all state variables that can be used to characterize a physical system. Examples of thermodynamic variables include, but are not limited to: pressure, temperature, airflow, humidity, and particulate matter. Further, the term “model” refers generally to a description or representation of a system. The description or representation can use mathematical language, such as in the case of mathematical models. Examples of such models used herein include state-space model or multi-input, multi-output systems.

The thermal model described herein can enable a thermostat and/or servers to compute accurate predictions related to temperature, humidity, HVAC runtime, and other factors pertaining to a particular enclosure. The results of the thermal model can be used by a thermostat contained within the enclosure to control the operation of the HVAC system. In addition, the results of the thermal model can be also used as data inputs to the company that sells the thermostat so that information can be further analyzed, for example, by more powerful computers. Further still, the analyzed results of the thermal model may be provided to third parties (e.g., an energy partner so that it can make better assessments of energy production). In yet another approach, third party providers may be granted access to the thermal model and/or its results via an API.

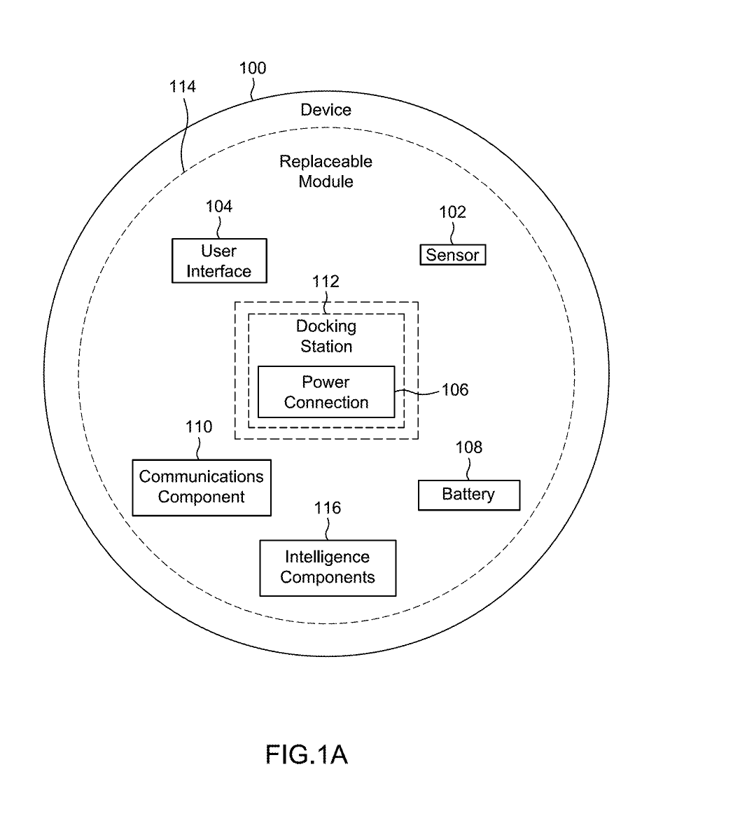

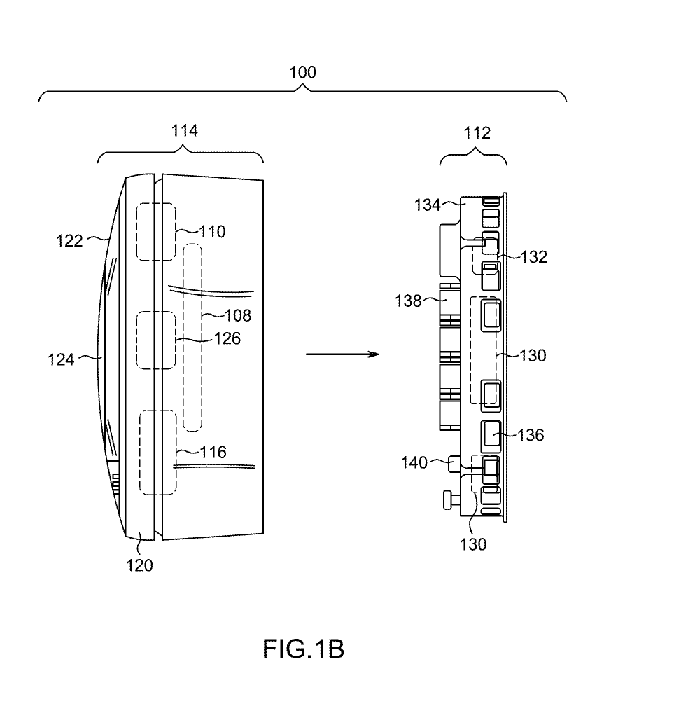

Turning now to the figures, FIG. 1A illustrates an example of general device components which can be included in an intelligent, network-connected device 100 (i.e., “device”) that may be used to implement one or more of the thermodynamic behavior prediction processes described herein according to an embodiment. Each of one, more or all devices 100 within a system of devices can include one or more sensors 102, a user-interface component 104, a power supply (e.g., including a power connection 106 and/or battery 108), a communications component 110, a modularity unit (e.g., including a docking station 112 and replaceable module 114) and intelligence components 116. Particular sensors 102, user-interface components 104, power-supply configurations, communications components 110, modularity units and/or intelligence components 116 can be the same or similar across devices 100 or can vary depending on device type or model.

Sensors 102 as described herein generally includes devices or systems that measure and/or register a substance, physical phenomenon and/or physical quantity. The sensor may convert a measurement into a signal, which can be interpreted by an observer, instrument and/or system. A sensor can be implemented as a special purpose device and/or can be implemented as software running on a general-purpose computer system. By way of example and not by way of limitation, one or more sensors 102 in a device 100 may be able to, e.g., detect acceleration, temperature, humidity, water, supplied power, proximity, external motion, device motion, sound signals, ultrasound signals, light signals, fire, smoke, carbon monoxide, global-positioning-satellite (GPS) signals, or radio-frequency (RF) or other electromagnetic signals or fields. Thus, for example, sensors 102 can include temperature sensor(s), humidity sensor(s), hazard-related sensor(s) or other environmental sensor(s), accelerometer(s), microphone(s), optical sensor(s) up to and including camera(s) (e.g., charged-coupled-device or video cameras), active or passive radiation sensor(s), GPS receiver(s) or radio-frequency identification detector(s). While FIG. 1A illustrates an embodiment with a single sensor, many embodiments will include multiple sensors. In some instances, device 100 includes one or more primary sensors and one or more secondary sensors. The primary sensor(s) can sense data central to the core operation of the device (e.g., sensing a temperature in a thermostat or sensing smoke in a smoke detector). The secondary sensor(s) can sense other types of data (e.g., motion, light or sound), which can be used for energy-efficiency objectives or smart-operation objectives. In some instances, an average user may even be unaware of an existence of a secondary sensor.

One or more user-interface components 104 in device 100 may be configured to present information to a user via a visual display (e.g., a thin-film-transistor display or organic light-emitting-diode display) and/or an audio speaker and/or some other communication medium. User-interface component 104 can also include one or more user-input components to receive information from a user, such as a touchscreen, buttons, scroll component (e.g., a movable or virtual ring component), microphone or camera (e.g., to detect gestures). In one embodiment, user-input component 104 includes a click-and-rotate annular ring component, wherein a user can interact with the component by rotating the ring (e.g., to adjust a setting) and/or by clicking the ring inwards (e.g., to select an adjusted setting or to select an option). In another embodiment, user-input component 104 includes a camera, such that gestures can be detected (e.g., to indicate that a power or alarm state of a device is to be changed).

A power-supply component in device 100 may include a power connection 106 and/or local battery 108. For example, power connection 106 can connect device 100 to a power source such as a line voltage source. In some instances, connection 106 to an AC power source can be used to repeatedly charge a (e.g., rechargeable) local battery 108, such that battery 108 can later be used to supply power if needed in the event of an AC power disconnection or other power deficiency scenario.

A communications component 110 in device 100 can include a component that enables device 100 to communicate with a central server or a remote device, such as another device described herein or a portable user device. Communications component 110 can allow device 100 to communicate via, e.g., Wi-Fi, ZigBee, 3G/4G wireless, CAT6 wired Ethernet, HomePlug or other powerline communications method, telephone, or optical fiber, by way of non-limiting examples. Communications component 110 can include a wireless card, an Ethernet plug, or another transceiver connection. In some embodiments, the communications component 110 facilitates communication with a central server to synchronize information between device 100, the central server, and in some cases additional devices. Techniques for synchronizating data between such devices are further described in the commonly assigned U.S. Pat. No. 8,635,373, the contents of which are incorporated by reference herein in their entirety for all purposes.

A modularity unit in device 100 can include a static physical connection, and a replaceable module 114. Thus, the modularity unit can provide the capability to upgrade replaceable module 114 without completely reinstalling device 100 (e.g., to preserve wiring). The static physical connection can include a docking station 112 (which may also be termed an interface box) that can attach to a building structure. For example, docking station 112 could be mounted to a wall via screws or stuck onto a ceiling via adhesive. Docking station 112 can, in some instances, extend through part of the building structure. For example, docking station 112 can connect to wiring (e.g., to 120V line voltage wires) behind the wall via a hole made through a wall's sheetrock. Docking station 112 can include circuitry such as power-connection circuitry 106 and/or AC-to-DC powering circuitry and can prevent the user from being exposed to high-voltage wires. Docking station 112 may also or alternatively include control circuitry for actuating (i.e., turning on and off) elements of an HVAC system, such as a heating unit (for heating the building structure), an air-condition unit (for cooling the building structure), and/or a ventilation unit (for circulating air throughout the building structure). In some instances, docking stations 112 are specific to a type or model of device, such that, e.g., a thermostat device includes a different docking station than a smoke detector device. In some instances, docking stations 112 can be shared across multiple types and/or models of devices 100.

Replaceable module 114 of the modularity unit can include some or all sensors 102, processors, user-interface components 104, batteries 108, communications components 110, intelligence components 116 and so forth of the device. Replaceable module 114 can be configured to attach to (e.g., plug into or connect to) docking station 112. In some instances, a set of replaceable modules 114 are produced with the capabilities, hardware and/or software, varying across the replaceable modules 114. Users can therefore easily upgrade or replace their replaceable module 114 without having to replace all device components or to completely reinstall device 100. For example, a user can begin with an inexpensive device including a first replaceable module with limited intelligence and software capabilities. The user can then easily upgrade the device to include a more capable replaceable module. As another example, if a user has a Model #1 device in their basement, a Model #2 device in their living room, and upgrades their living-room device to include a Model #3 replaceable module, the user can move the Model #2 replaceable module into the basement to connect to the existing docking station. The Model #2 replaceable module may then, e.g., begin an initiation process in order to identify its new location (e.g., by requesting information from a user via a user interface).

Intelligence components 116 of the device can support one or more of a variety of different device functionalities. Intelligence components 116 generally include one or more processors configured and programmed to carry out and/or cause to be carried out one or more of the advantageous functionalities described herein. The intelligence components 116 can be implemented in the form of general-purpose processors carrying out computer code stored in local memory (e.g., flash memory, hard drive, random access memory), special-purpose processors or application-specific integrated circuits, combinations thereof, and/or using other types of hardware/firmware/software processing platforms. The intelligence components 116 can furthermore be implemented as localized versions or counterparts of algorithms carried out or governed remotely by central servers or cloud-based systems, such as by virtue of running a Java virtual machine (JVM) that executes instructions provided from a cloud server using Asynchronous Javascript and XML (AJAX) or similar protocols. By way of example, intelligence components 116 can be configured to detect when a location (e.g., a house or room) is occupied, up to and including whether it is occupied by a specific person or is occupied by a specific number and/or set of people (e.g., relative to one or more thresholds). Such detection can occur, e.g., by analyzing microphone signals, detecting user movements (e.g., in front of a device), detecting openings and closings of doors or garage doors, detecting wireless signals, detecting an IP address of a received signal, or detecting operation of one or more devices within a time window. Intelligence components 116 may include image-recognition technology to identify particular occupants or objects.

In some instances, intelligence components 116 can be configured to predict desirable settings and/or to implement those settings. For example, based on the presence detection, intelligence components 116 can adjust device settings to, e.g., conserve power when nobody is home or in a particular room or to accord with user preferences (e.g., general at-home preferences or user-specific preferences). As another example, based on the detection of a particular person, animal or object (e.g., a child, pet or lost object), intelligence components 116 can initiate an audio or visual indicator of where the person, animal or object is or can initiate an alarm or security feature if an unrecognized person is detected under certain conditions (e.g., at night or when lights are out). As yet another example, intelligence components 116 can detect hourly, weekly or even seasonal trends in user settings and adjust settings accordingly. For example, intelligence components 116 can detect that a particular device is turned on every week day at 6:30 am, or that a device setting is gradually adjusted from a high setting to lower settings over the last three hours. Intelligence components 116 can then predict that the device is to be turned on every week day at 6:30 am or that the setting should continue to gradually lower its setting over a longer time period.

In some instances, devices can interact with each other such that events detected by a first device influence actions of a second device. For example, a first device can detect that a user has pulled into a garage (e.g., by detecting motion in the garage, detecting a change in light in the garage or detecting opening of the garage door). The first device can transmit this information to a second device, such that the second device can, e.g., adjust a home temperature setting, a light setting, a music setting, and/or a security-alarm setting. As another example, a first device can detect a user approaching a front door (e.g., by detecting motion or sudden light-pattern changes). The first device can, e.g., cause a general audio or visual signal to be presented (e.g., such as sounding of a doorbell) or cause a location-specific audio or visual signal to be presented (e.g., to announce the visitor's presence within a room that a user is occupying).

FIG. 1B illustrates an intelligent, network-connected device 100 having a replaceable module 114 (e.g., a head unit) and a docking station 112 (e.g., a back plate) for ease of installation, configuration, and upgrading according to an embodiment. As is described hereinabove, device 100 may be wall mounted, have a circular shape, and have an outer rotatable ring 120 (that may be, e.g., part of user interface 104) for receiving user input. Outer rotatable ring 120 allows the user to make adjustments, such as selecting a new target temperature. For example, by rotating outer ring 120 clockwise, a target setpoint temperature can be increased, and by rotating the outer ring 120 counter-clockwise, the target setpoint temperature can be decreased. Changes to an existing setpoint temperature that reflect a desire for the temperature in the structure to be immediately changed to that setpoint temperature may herein be referred to as changes to an “immediate setpoint temperature” or a “current setpoint temperature”. This is in contrast to setpoint temperatures that may be provided in a hourly, daily, weekly, monthly, or other schedule in which setpoint temperatures may reflect a desire for future temperatures in the structure. Such setpoint temperatures may herein be referred as “scheduled setpoint temperature” or as a “schedule of setpoint temperatures”.

Device 100 has a cover 122 that includes a display 124 (that may be, e.g., part of user interface 104). Head unit 114 slides onto back plate 112. Display 124 may display a variety of information depending on, e.g., a current operational state of the device 100, direct user interaction with the device via ring 120, sensed presence of the user via, e.g., a proximity sensor 102 (such as a passive infrared motion sensor), remote user interaction with the device via a remote access device, etc. For example, display 124 may display central numerals that are representative of a current setpoint temperature.

According to some embodiments the connection of the head unit 114 to back plate 112 can be accomplished using magnets, bayonet, latches and catches, tabs or ribs with matching indentations, or simply friction on mating portions of the head unit 114 and back plate 112. According to some embodiments, the head unit 114 includes battery 108, communications component 110, intelligence components 116, and a display driver 126 (that may be, e.g., part of user interface 104). Battery 108 may be recharged using recharging circuitry (that may be, e.g., part of intelligence components 116 and/or may be included in the back plate 112) that uses power from the back plate 112 that is either obtained via power harvesting (also referred to as power stealing and/or power sharing) from the HVAC system control circuit(s) or from a common wire, if available. According to some embodiments, battery 108 is a rechargeable single cell lithium-ion, or a lithium-polymer battery.

Back plate 112 includes electronics 130 and a temperature sensor 132 (that may be, e.g., one of sensors 102) in housing 134, which are ventilated via vents 136. Temperature sensor 132 allows the back plate 112 to operate as a fully functional thermostat even when not connected to the head unit 114. Wire connectors 138 are provided to allow for connection to HVAC system wires, such as connection to wires for actuating components of the HVAC system, wires for receiving power from the HVAC system, etc. Connection terminal 140 is a male or female plug connector that provides electrical connections between the head unit 114 and back plate 112.

In some embodiments, the back plate electronics 130 includes an MCU processor, and driver circuitry for opening and closing the HVAC control circuits, thereby turning on and turning off the one or more HVAC functions such as heating and cooling. The electronics 130 also includes flash memory which is used to store a series of programmed settings that take effect at different times of the day, such that programmed setpoint (i.e., desired temperature) changes can be carried out even when the head unit 114 is not attached to the back plate 112. According to some embodiments, the electronics 130 also includes power harvesting circuitry (that may be in addition or alternatively to that provided in head unit 114) to obtain power from the HVAC control circuit(s) even when an HVAC common power wire is not available.

Device 100 in certain embodiments is an intelligent, network-connected learning thermostat that includes various components such as a head unit, a back plate, a user interface, communications components, intelligent components, etc. However, it will be appreciated by those skilled in the art that devices that perform the various operations described herein could operate equally well with fewer or a greater number of components than are illustrated in FIGS. 1A and 1B. Thus, the depiction of device 100 in FIGS. 1A and 1B should be taken as being illustrative in nature, and not limiting to the scope of the present teachings.

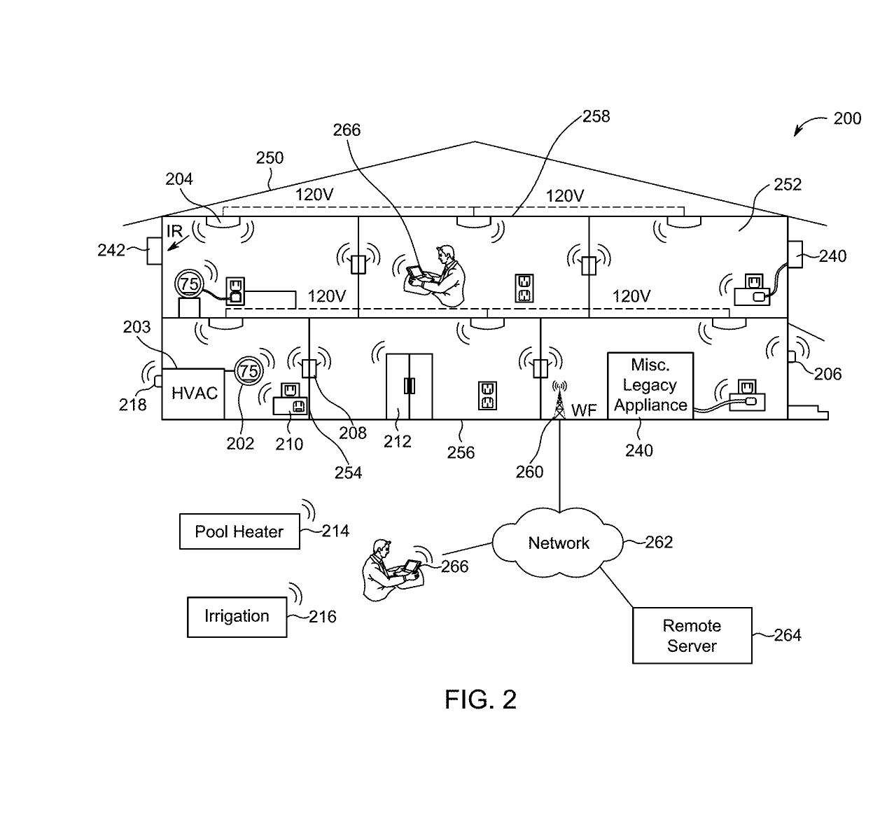

FIG. 2 illustrates an example of a smart home environment 200 within which one or more of the devices, methods, systems, services, and/or computer program products described further herein can be applicable according to an embodiment. The depicted smart home environment includes a structure 250, which can include, e.g., a house, office building, garage, mobile home, or other type of enclosure for which thermodynamic behavior may be predicted. It will be appreciated that devices can also be integrated into a smart home environment that does not include an entire structure 250, such as an apartment, condominium, or office space. Further, the smart home environment can control and/or be coupled to devices outside of the actual structure 250. Indeed, several devices in the smart home environment need not physically be within the structure 250 at all. For example, a device controlling a pool heater or irrigation system can be located outside of the structure 250.

The smart home environment 200 includes a plurality of rooms 252, separated at least partly from each other via walls 254. The walls 254 can include interior walls or exterior walls. Each room can further include a floor 256 and a ceiling 258. Devices can be mounted on, integrated with and/or supported by a wall 254, floor 256 or ceiling 258. The various devices that may be incorporated within the smart home environment 200 include intelligent, multi-sensing, network-connected devices that can integrate seamlessly with each other and/or with cloud-based server systems to provide any of a variety of useful smart home objectives. An intelligent, multi-sensing, network-connected thermostat 202 can detect ambient climate characteristics (e.g., temperature and/or humidity) and control a heating, ventilation and air-conditioning (HVAC) system 203. It should be recognized that while control of an HVAC system is described herein, similar principles can equally be applied to controlling other temperature/humidity control systems, such as a heating system, an air conditioning system, a humidity control system, or any combination thereof. One or more intelligent, network-connected, multi-sensing hazard detection units 204 can detect the presence of a hazardous substance and/or a hazardous condition in the home environment (e.g., smoke, fire, or carbon monoxide). One or more intelligent, multi-sensing, network-connected entryway interface devices 206, which can be termed a “smart doorbell”, can detect a person's approach to or departure from a location, control audible functionality, announce a person's approach or departure via audio or visual means, or control settings on a security system (e.g., to activate or deactivate the security system).

In some embodiments, the smart home may include at least one energy consumption meter 218 such as a smart meter. The energy consumption meter 218 monitors some or all energy (electricity, gas, etc.) consumed by the devices in and around the structure 250. The energy consumption meter 218 may display the amount of energy consumed over a given period of time on a surface of the meter 218. The given period may be, e.g., a second, a minute, an hour, a day, a month, a time span less than one second, a time span greater than a month, or a time span between one second and one month. In some embodiments, the energy consumption meter 218 may include communication capabilities (wired or wireless) that enable the meter 218 to communicate various information, e.g., the amount of energy consumed over one or more given periods, the price of energy at any particular time or during any particular period of time, etc. The communication capabilities may also enable the meter to receive various information. For example, the meter may receive instructions for controlling one or more devices in the smart home such as the HVAC system 203, the price of energy at any particular time or during any particular period of time, etc. To facilitate control of devices in and around the structure 250, the meter 218 may be wired or wirelessly connected to such devices.

Each of a plurality of intelligent, multi-sensing, network-connected wall light switches 208 can detect ambient lighting conditions, detect room-occupancy states and control a power and/or dim state of one or more lights. In some instances, light switches 208 can further or alternatively control a power state or speed of a fan, such as a ceiling fan. Each of a plurality of intelligent, multi-sensing, network-connected wall plug interfaces 210 can detect occupancy of a room or enclosure and control supply of power to one or more wall plugs (e.g., such that power is not supplied to the plug if nobody is at home). The smart home may further include a plurality of intelligent, multi-sensing, network-connected appliances 212, such as refrigerators, stoves and/or ovens, televisions, washers, dryers, lights (inside and/or outside the structure 250), stereos, intercom systems, garage-door openers, floor fans, ceiling fans, whole-house fans, wall air conditioners, pool heaters 214, irrigation systems 216, security systems, and so forth. While descriptions of FIG. 2 can identify specific sensors and functionalities associated with specific devices, it will be appreciated that any of a variety of sensors and functionalities (such as those described throughout the specification) can be integrated into the device.

In addition to containing processing and sensing capabilities, each of the devices within the smart home environment 200 can be capable of data communications and information sharing with any other devices within the smart home environment 200, as well as to any devices outside the smart home environment 240 such as the access device 266 and/or remote server 264. The devices can send and receive communications via any of a variety of custom or standard wireless protocols (Wi-Fi, ZigBee, 6LoWPAN, IR, IEEE 802.11, IEEE 802.15.4, etc.) and/or any of a variety of custom or standard wired protocols (CAT6 Ethernet, HomePlug, etc.). The wall plug interfaces 210 can serve as wireless or wired repeaters, and/or can function as bridges between (i) devices plugged into AC outlets and communicating using Homeplug or other power line protocol, and (ii) devices that are not plugged into AC outlets.

For example, a first device can communicate with a second device via a wireless router 260. A device can further communicate with remote devices via a connection to a network, such as the network 262. Through the network 262, the device can communicate with a central (i.e., remote) server or a cloud-computing system 264. The remote server or cloud-computing system 264 can be associated with a manufacturer, support entity or service provider associated with the device. In one embodiment, a user may be able to contact customer support using a device itself rather than needing to use other communication means such as a telephone or Internet-connected computer.

Devices' network connections can further allow a user to interact with the device even if the user is not proximate to the device. For example, a user can communicate with a device (e.g., thermostat 202) using a computer (e.g., a desktop computer, laptop computer, or tablet) or other portable electronic device (e.g., a smartphone) 266. A webpage or app can be configured to receive communications from the user and control the device based on the communications and/or to present information about the device's operation to the user. For example, when the portable electronic device 266 is being used to interact with the thermostat 202, the user can view a current setpoint temperature for a thermostat and adjust it using the portable electronic device 266. The user can be in the structure during this remote communication or outside the structure. The communications between the portable electronic device 266 and the thermostat 202 may be routed via the remote server 264 (e.g., when the portable electronic device 266 is remote from structure 250) or, in some embodiments, may be routed exclusive of the remote server 264.

The smart home environment 200 also can include a variety of non-communicating legacy appliances 240, such as old conventional washer/dryers, refrigerators, and the like which can be controlled, albeit coarsely (ON/OFF), by virtue of the wall plug interfaces 210. The smart home can further include a variety of partially communicating legacy appliances 242, such as IR-controlled wall air conditioners or other IR-controlled devices, which can be controlled by IR signals provided by the hazard detection units 204 or the light switches 208 or, in some embodiments, by using socket-based communication protocol such as powerline to communicate via a wall plug interface 210.

Smart home 200 in certain embodiments is an environment including a number of client devices and access devices all operable to communicate with one another as well as with devices or systems external to the smart home 200 such as remote server 264. However, it will be appreciated by those skilled in the art that such an environment could operate equally well having fewer or a greater number of components than are illustrated in FIG. 2. Thus, the depiction of the smart home environment 200 in FIG. 2 should be taken as being illustrative in nature, and not limiting to the scope of the present teachings.

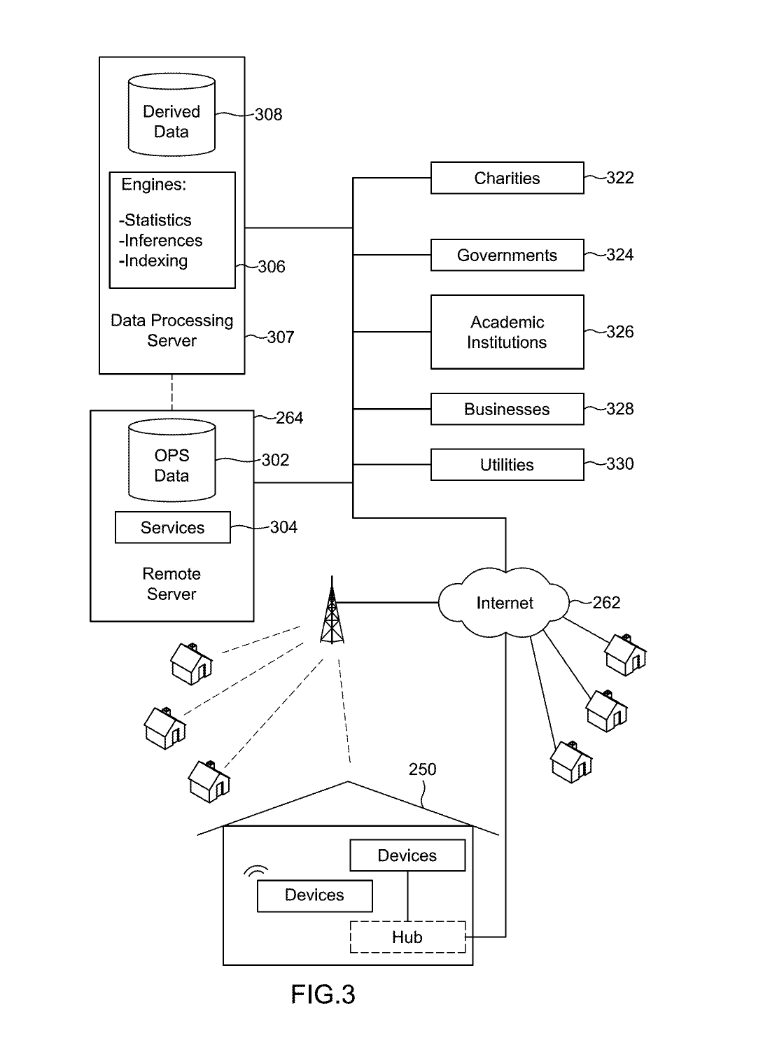

FIG. 3 illustrates a network-level view of an extensible devices and services platform with which the smart home of FIGS. 1 and/or 2 can be integrated according to an embodiment. Each of the intelligent, network-connected devices discussed with reference to FIG. 2 can communicate with one or more remote servers or cloud computing systems 264. The communication can be enabled by establishing connection to the Internet 262 either directly (for example, using 3G/4G connectivity to a wireless carrier), though a hubbed network (which can be a scheme ranging from a simple wireless router, for example, up to and including an intelligent, dedicated whole-home control node), or through any combination thereof.

The remote server or cloud-computing system 264 can collect operation data 302 from the smart home devices. For example, the devices can routinely transmit operation data or can transmit operation data in specific instances (e.g., when requesting customer support). The remote server or cloud-computing architecture 264 can further provide one or more services 304. The services 304 can include, e.g., software update, customer support, sensor data collection/logging, remote access, remote or distributed control, or use suggestions (e.g., based on collected operation data 304 to improve performance, reduce utility cost, etc.). Data associated with the services 304 can be stored at the remote server or cloud-computing system 264 and the remote server or cloud-computing system 264 can retrieve and transmit the data at an appropriate time (e.g., at regular intervals, upon receiving request from a user, etc.).

One salient feature of the described extensible devices and services platform, as illustrated in FIG. 3, is a processing engine 306, which can be concentrated at a single data processing server 307 (which may be included in or separate from remote server 264) or distributed among several different computing entities without limitation. Processing engine 306 can include engines configured to receive data from a set of devices (e.g., via the Internet or a hubbed network), to index the data, to analyze the data and/or to generate statistics based on the analysis or as part of the analysis. The analyzed data can be stored as derived data 308. Results of the analysis or statistics can thereafter be transmitted back to a device providing ops data used to derive the results, to other devices, to a server providing a webpage to a user of the device, or to other non-device entities. For example, use statistics, use statistics relative to use of other devices, use patterns, and/or statistics summarizing sensor readings can be transmitted. The results or statistics can be provided via the Internet 262. In this manner, processing engine 306 can be configured and programmed to derive a variety of useful information from the operational data obtained from the smart home. A single server can include one or more engines.

The derived data can be highly beneficial at a variety of different granularities for a variety of useful purposes, ranging from explicit programmed control of the devices on a per-home, per-neighborhood, or per-region basis (for example, demand-response programs for electrical utilities), to the generation of inferential abstractions that can assist on a per-home basis (for example, an inference can be drawn that the homeowner has left for vacation and so security detection equipment can be put on heightened sensitivity), to the generation of statistics and associated inferential abstractions that can be used for government or charitable purposes. For example, the processing engine 306 can generate statistics about device usage across a population of devices and send the statistics to device users, service providers or other entities (e.g., that have requested or may have provided monetary compensation for the statistics). As specific illustrations, statistics can be transmitted to charities 322, governmental entities 324 (e.g., the Food and Drug Administration or the Environmental Protection Agency), academic institutions 326 (e.g., university researchers), businesses 328 (e.g., providing device warranties or service to related equipment), or utility companies 330. These entities can use the data to form programs to reduce energy usage, to preemptively service faulty equipment, to prepare for high service demands, to track past service performance, etc., or to perform any of a variety of beneficial functions or tasks now known or hereinafter developed.

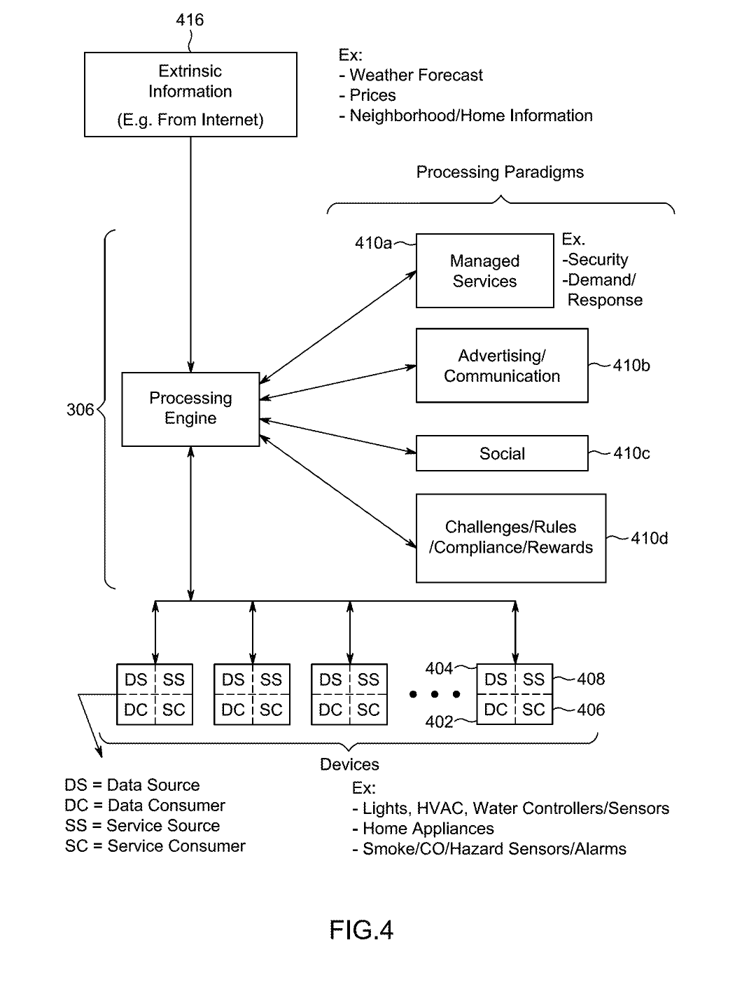

FIG. 4 illustrates an abstracted functional view of the extensible devices and services platform of FIG. 3, with particular reference to the processing engine 306 as well as the devices of the smart home environment, according to an embodiment. Even though the devices situated in the smart home have an endless variety of different individual capabilities and limitations, they can all be thought of as sharing common characteristics in that each of them is a data consumer 402 (DC), a data source 404 (DS), a services consumer 406 (SC), and/or a services source 408 (SS). Advantageously, in addition to providing the essential control information needed for the devices to achieve their local and immediate objectives, the extensible devices and services platform can also be configured to harness the large amount of data that is flowing out of these devices. In addition to enhancing or optimizing the actual operation of the devices themselves with respect to their immediate functions, the extensible devices and services platform can also be directed to “repurposing” that data in a variety of automated, extensible, flexible, and/or scalable ways to achieve a variety of useful objectives. These objectives may be predefined or adaptively identified based on, e.g., usage patterns, device efficiency, and/or user input (e.g., requesting specific functionality).

For example, FIG. 4 shows processing engine 306 as including a number of paradigms 410. Processing engine 306 can include a managed services paradigm 410 a that monitors and manages primary or secondary device functions. The device functions can include ensuring proper operation of a device given user inputs, estimating that (e.g., and responding to) an intruder is or is attempting to be in a dwelling, detecting a failure of equipment coupled to the device (e.g., a light bulb having burned out), implementing or otherwise responding to energy demand response events, or alerting a user of a current or predicted future event or characteristic. Processing engine 306 can further include an advertising/communication paradigm 410 b that estimates characteristics (e.g., demographic information), desires and/or products of interest of a user based on device usage. Services, promotions, products or upgrades can then be offered or automatically provided to the user. Processing engine 306 can further include a social paradigm 410 c that uses information from a social network, provides information to a social network (for example, based on device usage), and/or processes data associated with user and/or device interactions with the social network platform. For example, a user's status as reported to their trusted contacts on the social network could be updated to indicate when they are home based on light detection, security system inactivation or device usage detectors. As another example, a user may be able to share device-usage statistics with other users. Processing engine 306 can include a challenges/rules/compliance/rewards paradigm 410 d that informs a user of challenges, rules, compliance regulations and/or rewards and/or that uses operation data to determine whether a challenge has been met, a rule or regulation has been complied with and/or a reward has been earned. The challenges, rules or regulations can relate to efforts to conserve energy, to live safely (e.g., reducing exposure to toxins or carcinogens), to conserve money and/or equipment life, to improve health, etc.

Processing engine 306 can integrate or otherwise utilize extrinsic information 416 from extrinsic sources to improve the functioning of one or more processing paradigms. Extrinsic information 416 can be used to interpret operational data received from a device, to determine a characteristic of the environment near the device (e.g., outside a structure that the device is enclosed in), to determine services or products available to the user, to identify a social network or social-network information, to determine contact information of entities (e.g., public-service entities such as an emergency-response team, the police or a hospital) near the device, etc., to identify statistical or environmental conditions, trends or other information associated with a home or neighborhood, and so forth.

An extraordinary range and variety of benefits can be brought about by, and fit within the scope of, the described extensible devices and services platform, ranging from the ordinary to the profound. Thus, in one “ordinary” example, each bedroom of the smart home can be provided with a smoke/fire/CO alarm that includes an occupancy sensor, wherein the occupancy sensor is also capable of inferring (e.g., by virtue of motion detection, facial recognition, audible sound patterns, etc.) whether the occupant is asleep or awake. If a serious fire event is sensed, the remote security/monitoring service or fire department is advised of how many occupants there are in each bedroom, and whether those occupants are still asleep (or immobile) or whether they have properly evacuated the bedroom. While this is, of course, a very advantageous capability accommodated by the described extensible devices and services platform, there can be substantially more “profound” examples that can truly illustrate the potential of a larger “intelligence” that can be made available. By way of perhaps a more “profound” example, the same data bedroom occupancy data that is being used for fire safety can also be “repurposed” by the processing engine 306 in the context of a social paradigm of neighborhood child development and education. Thus, for example, the same bedroom occupancy and motion data discussed in the “ordinary” example can be collected and made available for processing (properly anonymized) in which the sleep patterns of schoolchildren in a particular ZIP code can be identified and tracked. Localized variations in the sleeping patterns of the schoolchildren may be identified and correlated, for example, to different nutrition programs in local schools.

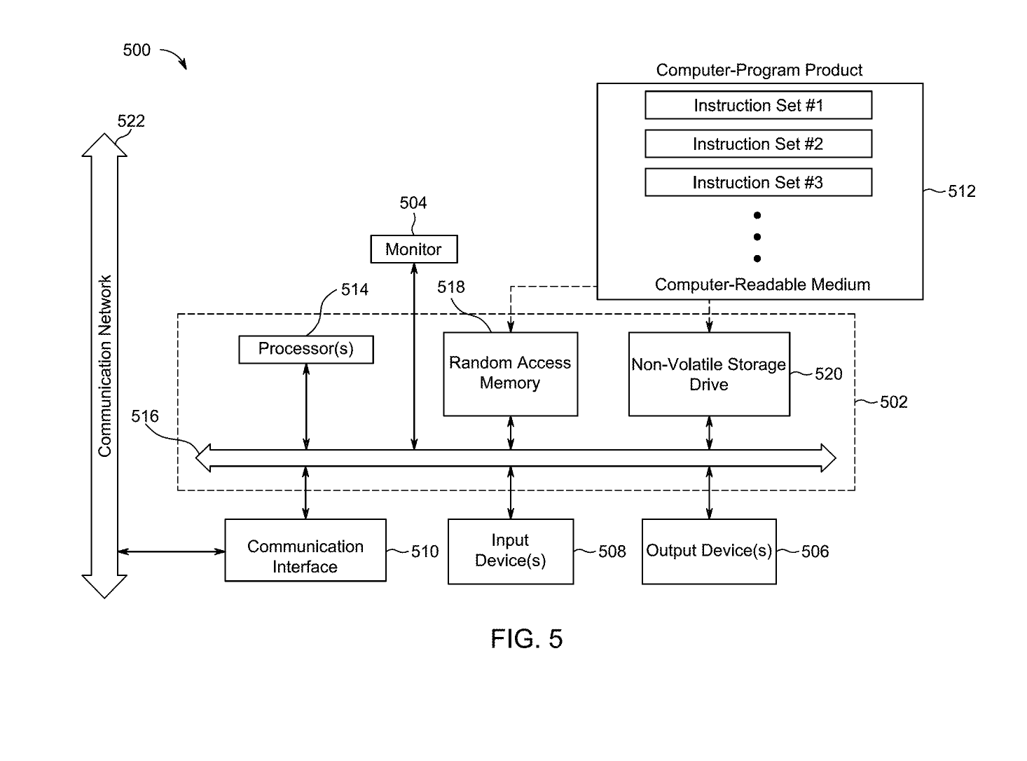

FIG. 5 is a block diagram of a special-purpose computer system 500 according to an embodiment. For example, one or more of client device 100, elements of smart home environment 200, remote server 264, processing engine 306, data processing server 307, or other electronic components described herein may be implemented as a special-purpose computer system 500. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 500 comprises a computer 502, a monitor 504 coupled to computer 502, one or more additional user output devices 506 (optional) coupled to computer 502, one or more user input devices 508 (e.g., keyboard, mouse, track ball, touch screen) coupled to computer 502, an optional communications interface 510 coupled to computer 502, and a computer-program product including a tangible computer-readable storage medium 512 in or accessible to computer 502. Instructions stored on computer-readable storage medium 512 may direct system 500 to perform the methods and processes described herein. Computer 502 may include one or more processors 514 that communicate with a number of peripheral devices via a bus subsystem 516. These peripheral devices may include user output device(s) 506, user input device(s) 508, communications interface 510, and a storage subsystem, such as random access memory (RAM) 518 and non-volatile storage drive 520 (e.g., disk drive, optical drive, solid state drive), which are forms of tangible computer-readable memory.

Computer-readable medium 512 may be loaded into random access memory 518, stored in non-volatile storage drive 520, or otherwise accessible to one or more components of computer 502. Each processor 514 may comprise a microprocessor, such as a microprocessor from Intel® or Advanced Micro Devices, Inc.®, or the like. To support computer-readable medium 512, the computer 502 runs an operating system that handles the communications between computer-readable medium 512 and the above-noted components, as well as the communications between the above-noted components in support of the computer-readable medium 512. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 508 include all possible types of devices and mechanisms to input information to computer system 502. These may include a keyboard, a keypad, a mouse, a scanner, a digital drawing pad, a touch screen incorporated into the display, audio input devices such as voice recognition systems, microphones, and other types of input devices. In various embodiments, user input devices 508 are typically embodied as a computer mouse, a trackball, a track pad, a joystick, wireless remote, a drawing tablet, a voice command system. User input devices 508 typically allow a user to select objects, icons, text and the like that appear on the monitor 504 via a command such as a click of a button or the like. User output devices 506 include all possible types of devices and mechanisms to output information from computer 502. These may include a display (e.g., monitor 504), printers, non-visual displays such as audio output devices, etc.

Communications interface 510 provides an interface to other communication networks and devices and may serve as an interface to receive data from and transmit data to other systems, WANs and/or the Internet, via a wired or wireless communication network 522. Embodiments of communications interface 510 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 510 may be coupled to a computer network, to a FireWire® bus, or the like. In other embodiments, communications interface 510 may be physically integrated on the motherboard of computer 502, and/or may be a software program, or the like.

RAM 518 and non-volatile storage drive 520 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 518 and non-volatile storage drive 520 may be configured to store the basic programming and data constructs that provide the functionality of various embodiments of the present invention, as described above.

Software instruction sets that provide the functionality of the present invention may be stored in computer-readable medium 512, RAM 518, and/or non-volatile storage drive 520. These instruction sets or code may be executed by the processor(s) 514. Computer-readable medium 512, RAM 518, and/or non-volatile storage drive 520 may also provide a repository to store data and data structures used in accordance with the present invention. RAM 518 and non-volatile storage drive 520 may include a number of memories including a main random access memory (RAM) to store of instructions and data during program execution and a read-only memory (ROM) in which fixed instructions are stored. RAM 518 and non-volatile storage drive 520 may include a file storage subsystem providing persistent (non-volatile) storage of program and/or data files. RAM 518 and non-volatile storage drive 520 may also include removable storage systems, such as removable flash memory.

Bus subsystem 516 provides a mechanism to allow the various components and subsystems of computer 502 communicate with each other as intended. Although bus subsystem 516 is shown schematically as a single bus, alternative embodiments of the bus subsystem may utilize multiple busses or communication paths within the computer 502.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

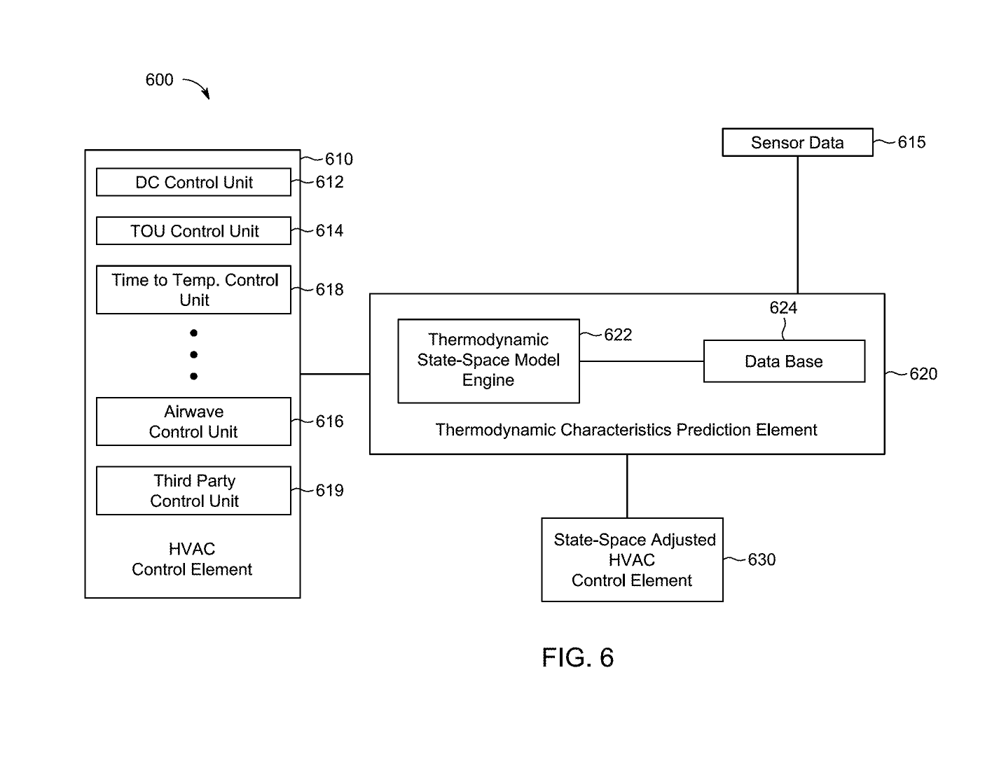

FIG. 6 illustrates components of an HVAC control system 600 implementing a state space thermodynamic model according to an embodiment. To facilitate understanding, the system 600 is described with reference to FIGS. 1A, 1B, 2, and 6-15, although it should be understood that embodiments of the system 600 are not limited to the exemplary apparatus and systems described with reference to FIGS. 1A, 1B, 2, and 6-15. HVAC control system 600 according to various embodiments is operable to implement a variety of HVAC control algorithms for intelligently controlling the indoor environmental conditions of a structure via an HVAC system. One of more of the HVAC control algorithms may rely, either directly or indirectly, on thermodynamic characterization of an enclosure that predicts how various inputs (e.g., HVAC operation, outdoor temperature, open doors or windows) affect various internal enclosure parameters (e.g., indoor temperature and humidity). The thermodynamic characterization may be based on a thermodynamic state-space model of the enclosure, where the thermodynamic state-space model characterizes thermodynamic characteristics of the enclosure. That is, for any multitude of different potential inputs into the enclosure, the model can predict a similar multitude of different predicted environmental conditions of the enclosure.

HVAC control system 600 according to some embodiments includes a variety of components, such as an HVAC control element 610, sensors 615, a thermodynamic characteristics prediction element 620, and a state-space adjusted HVAC control element 630. Each of these components may be physically, logically, or communicatively coupled to one another, and in some embodiments the structural elements and/or functionality thereof described herein for one or more components of system 600 may similarly be implemented in other components of system 600. Moreover, the components of system 600 can be implemented in hardware, software, or any combination thereof, and while in one embodiment the components of system 600 may be implemented in device 100, other embodiments are not so limited as either some or all of the components may be implemented in electronic devices (e.g., devices associated with smart home environment 200 such as portable electronic device 266 and/or remote server 264) other than device 100.

HVAC control element 610 includes HVAC control logic that, for one or more of a variety of reasons, may wish to obtain and use a prediction of the thermodynamic behavior of a structure. For example, one or more HVAC control algorithms implemented by thermostat 202 may rely on a prediction of the thermodynamic behavior of structure 250 to increase the accuracy of HVAC control. The HVAC element 610 may include HVAC control logic that spans a variety of possibilities, and may include and be implemented in, for example, a demand-response control unit 612, a time-of-use control unit 614, an airwave control unit 616, a time-to-temperature control unit 618, and third party control unit 619.

DR control unit 612 may be operable to control the HVAC system, e.g., HVAC 203, for a DR event. DR control unit 612 may include various control logic for facilitating such control, and in some cases such control logic may control the HVAC system so as to shift energy consumption from within a DR event period (i.e., a period of time during which reduced energy consumption is desired) to one or more time periods outside of the DR event period. In performing such control, the DR control unit 612 may at least partially rely on or more predictions of the thermodynamic characteristics of the enclosure.

Time-of-use (TOU) control unit 614 may be operable to control the HVAC system in environments where there is a dynamic pricing of energy. That is, the price per unit of energy as seen by the consumer may vary over the course of the day. The TOU control unit in this case may include various control logic for facilitating control of the HVAC system so as to achieve desired levels of occupant comfort while efficiently consuming energy over the course of the day in accordance with the dynamic pricing. In performing such control, the TOU control unit 614 may at least partially rely on one or more predictions of the thermodynamic characteristics of the enclosure.

Airwave control unit 616 may be operable to independently control an air compressor and fan for an air conditioning element of the HVAC system. While cooling the internal temperature of a structure to reach a desired setpoint temperature, airwave control unit 616 may disengage or otherwise turn off the compressor prior to reaching the desired setpoint temperature, while keeping the fan on for a certain period of time. In such a case, energy consumption by the HVAC system may be reduced while still achieving desired setpoint temperatures. In performing such control, the airwave control unit 616 may at least partially rely on one or more predictions of the thermodynamic characteristics of the enclosure.

Time-to-temperature control unit 618 may be operable to calculate and, in some embodiments, communicate to the user, the amount of time needed for the HVAC system to cause the internal temperature of the structure to reach a desired setpoint temperature. The use of such calculations may not be limited to communication to the user, but could also be used by other HVAC control logic, and the control unit 618 may not be limited to determining the time needed to reach a desired temperature but could also include logic for determining the time needed to reach other indoor environmental characteristics, such as a particular humidity level. In determining the time needed to reach an indoor environmental characteristic, the time-to-temperature control unit 618 may at least partially rely on one or more predictions of the thermodynamic characteristics of the enclosure.

Third party control unit 619 may be operable to enable third parties to access the thermodynamic model being implemented in thermodynamic characteristics prediction element 620. This enables the third party access to the thermodynamic model to, for example, perform data analysis, run scenarios indigenous to the enclosure, or perform other functions.

Sensor data 615 may represent data acquired by the various sensors and/or devices within an enclosure. Sensor data 615 may be acquired at regular intervals (e.g., once a minute) and stored in a database such as database 624.

It should be recognized that embodiments are not limited to HVAC control element 610 including the specific control units described herein, but rather could include one or more of a variety of control units that rely, at least in part, on predicted thermodynamic characteristics of an enclosure. To facilitate acquiring information indicative of such a prediction, in some embodiments the HVAC control element 610, or one or more units included therein, may communicate with the thermodynamic characteristics prediction element 620 in order to provide a state-space adjusted HVAC control element 630. That is, HVAC control element 610 may specify that the enclosure exhibit specific environmental conditions. This desire may be fed into thermodynamic characteristics prediction element 620, which can predict the environmental conditions of the enclosure based on a given set of inputs, historical observations, and can provide state-space adjusted controls instructions to the HVAC system to satisfy the desire of the HVAC control element 610. For example, HVAC element 610 may desire a specific internal temperature control trajectory of the enclosure. Thermal characteristic control element 620 can predict whether the desired internal temperature trajectory can be can achieved based on a current set of inputs, and based on that determination, the appropriate state-space adjusted HVAC control instructions can be provided to HVAC control element 630. For example, if the internal temperature trajectory cannot be obtained based on the current set of inputs, the HVAC control inputs may have to be modified to ensure that the internal temperature trajectory is obtained. Thermodynamic characteristic prediction element 620 can provide such HVAC control inputs (as part of the state-space adjusted HVAC control instructions).

Thermodynamic characteristics prediction element 620 includes computational logic that is operable to predict the thermodynamic behavior of a structure based historical observations of the enclosure, and inputs affecting the thermodynamics of the enclosure. Thermodynamic characteristics prediction element 620 may include a variety of computational logic for modeling such predictions, such as thermodynamic state-space model engine 622 and database 624. Thermodynamic state-space model engine 622 according to embodiments describe herein is a recursively learning model that characterizes the thermodynamic properties of an enclosure (e.g., structure such as a house) by taking any into any number of different inputs that affect the thermodynamic characteristics of the enclosure and learning from any errors in its predictions of any number of outputs generated to quantify environmental parameters of the enclosure based on actual internal enclosure parameter measurements fed back into the model. Database 624 can maintain historical information characterizing the enclosure and sensor data. The historical information can include all data collected over the lifetime of the enclosure thereby providing a comprehensive historical database for model engine 622 to leverage when modeling thermodynamic characteristics of the enclosure. The historical information stored in database 624 may be selectively updated with new data and with a bias to “forget” old data. This way, whenever relatively abrupt changes are introduced into the enclosure (e.g., a new sensor that provides additional measurement data or a new input), such changes are rapidly assimilated into to the database so that model engine 622 is provided with up-to-date data to provide more accurate predictions. This is in contrast with conventional database paradigms that have to rebuild a model from scratch whenever such an abrupt change is introduced. Model engine 622 is not constrained as such because its state-space representation of the enclosure immediately evolves in response to any new data stored in database 624.

The thermal model according to embodiments discussed herein can be represented by a linear multi input multi output (MIMO) system, and in particular can be represented by a linear time-invariant (LTI) state-space system. This advantageously makes the thermal model compatible with existing analyses tools and control strategies. In addition, the inputs for the thermal model can be actual physical factors that affect the thermal dynamics of the enclosure. This is in contrast to conventional models that empirically determine nonlinear inputs. In addition, the thermal model can be general model that is learned and mapped for example to different zones.

Further still, only one thermal model needs to be learned to predict all the different HVAC operational stages or states. This way, the relative strengths of each HVAC operational stage can be appropriately modeled. This is in contrast with conventional modeling techniques that have to create a separate model for each HVAC operational stage. For example, different HVAC operational stages can include no HVAC operations, first stage heat, first and second stage heat, and first, second, and auxiliary heat.

The thermal state-space model according to embodiments described herein can employ a recursive subspace identification algorithm that rapidly accommodates new additions of training data. The algorithm is recursive in the sense that the model has an intermediate state, which can be used as a history object, which can be stored in database 624. Whenever new training data becomes available, the history object is updated using only the new data. In addition, the algorithm can employ a “forgetting” factor that enables the thermal model to be adaptive over time. The thermal model may be initially programmed with an “out-of-the-box” history object. The out-of-the-box history object may be based on the thermostat's geographic location, the HVAC system the thermostat is controlling, enclosure type (e.g., house or office building), and any other suitable criteria. This enables the thermostat to begin immediate thermal modeling predictions, without having to wait for training data to be provided by various devices within the enclosure. The “forgetting” factor can enable the thermal model to evolve from the initial model and adapt to the actual thermodynamics of the enclosure.

The thermal model can be tunable to find a stable higher-order model. The ability to tune the order of the model enables the thermal model to account for higher order thermodynamics of the enclosure and thereby compute more accurate predictions (e.g., especially for short-cycle HVAC run-times). With each new set of training data, the recursive subspace identification algorithm can tune itself to the highest order model it can sustain. If a particular order model cannot be sustained, the algorithm may attempt to stabilize at a lower order model. And if no order model can be sustained, the set of new training data may be discarded and the model may revert back to the highest sustainable order.

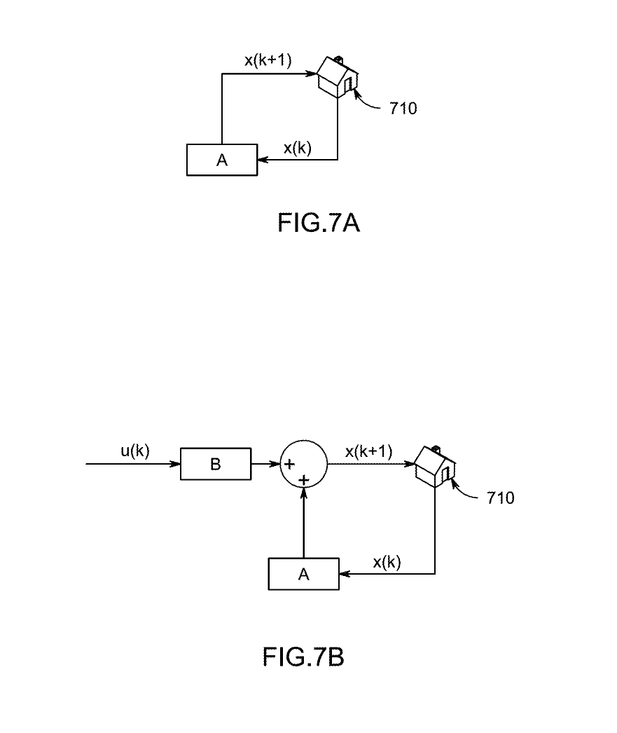

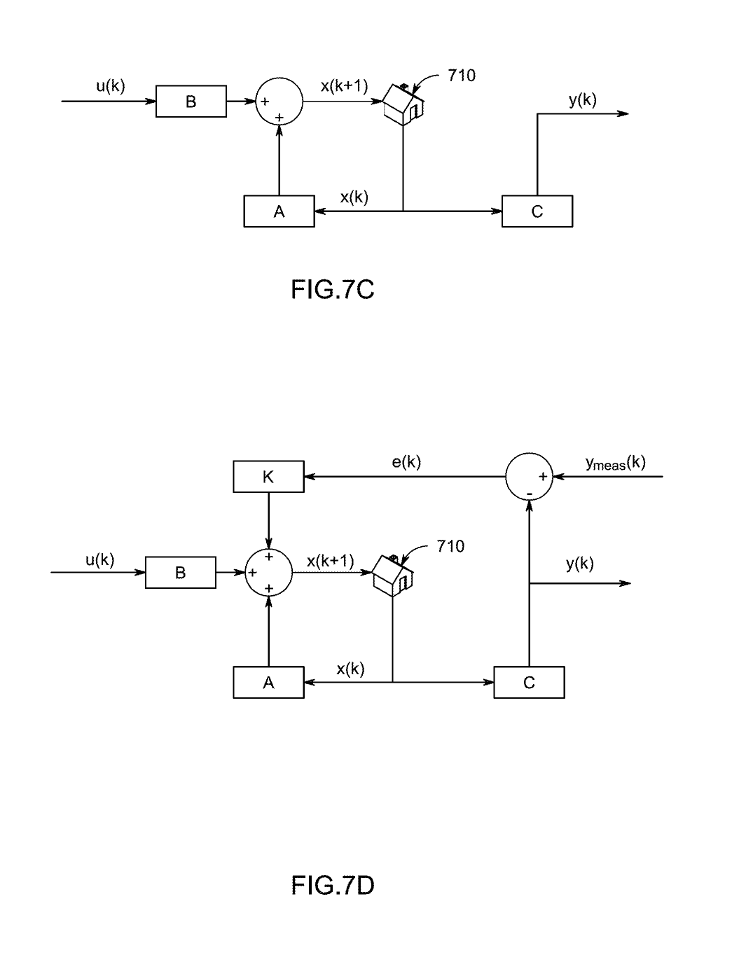

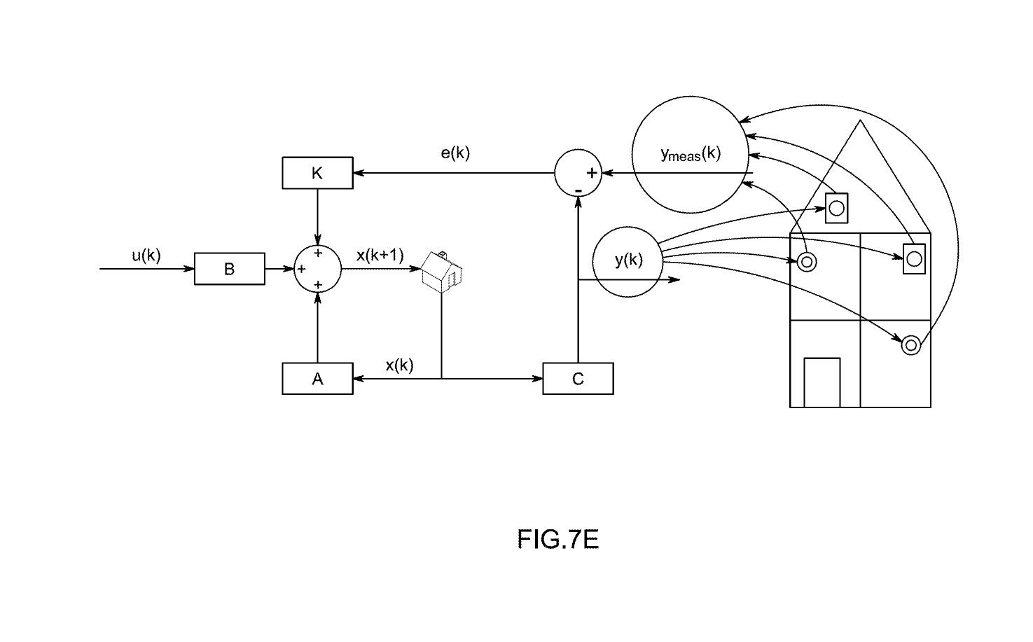

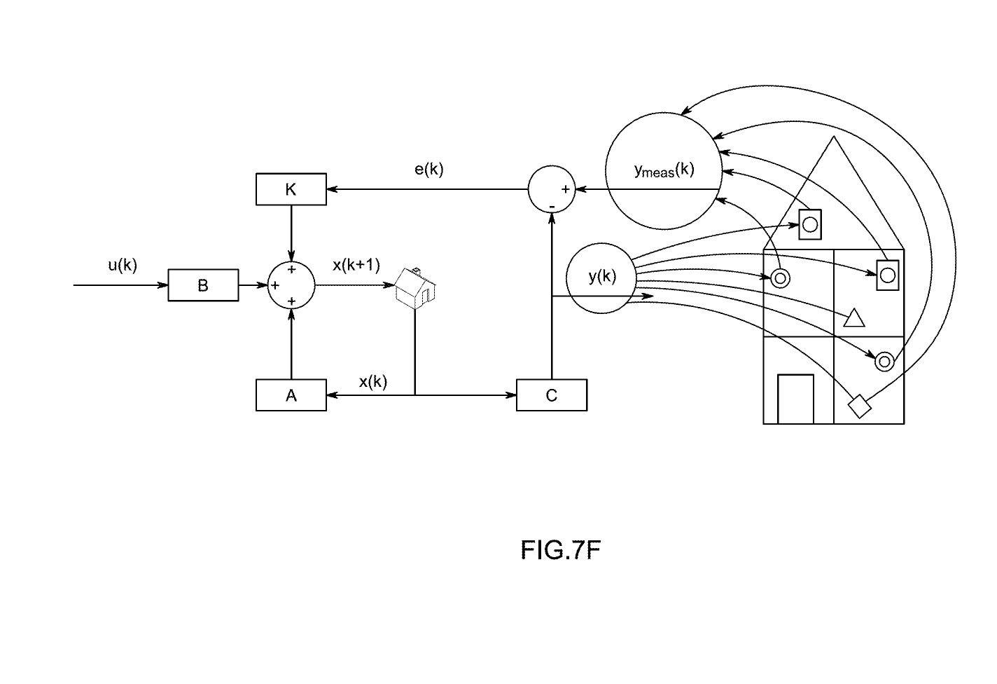

The thermal model according to embodiments discussed herein can be represented by the following state-space model:

$$\{ \begin{matrix}x ( k + 1 ) = Ax ( k ) + Bu ( k ) + Ke ( k ) \\ y ( k ) = Cx ( k )\end{matrix}$$

where x(k)εRⁿ, u(k)εR^{m}, y(k)εR¹. The vectors, x, u, e, and y, and mapping functions A, B, C, and K are explained below in connection with FIGS. 7A-7E.

FIG. 7A shows an illustrative schematic showing a portion of the state-space model defining the thermal model, according to an embodiment. The x represents an n-dimensional state vector that represents the internal state of enclosure 710. The k value represents the current time step, and the k+1 value represents the next time step. The A represents a mapping function from the current state to the next state. Thus, even without inputs, outputs, or correction factors, the predicted internal state of enclosure 710 can evolve. In some embodiments, the A mapping function may represent the order of the thermodynamic model, and thus may remain fixed unless the order of the model is changed.

FIG. 7B shows another illustrative schematic showing another portion of the state-space model that builds on the schematic of FIG. 7A, according to an embodiment. FIG. 7B introduces u and B, where u represents an m-dimensional input vector that has an impact on the state of enclosure 710. The variables of the input vector, u, can include, for example, the outdoor temperature, the various HVAC operation stages, humidity, occupancy, ambient light, window states, door states, and any other factors that can affect the internal state of enclosure 710. For example, in one embodiment, the input vector, u(k) can be defined as follows: u(k)=[T_{outdoor}(k) HVAC_{stage1heat}(k) . . . HVACₐᵤₓₕₑₐₜ(k)]^{T}. The B mapping function can represent a mapping that the inputs have on affecting the state of the enclosure. Thus, the state x(k+1) can include the state of the previous step, x(k), the input, u(k), and mapping function B.

FIG. 7C shows yet another illustrative schematic showing another portion of the state-space model that builds on the schematic of FIG. 7B, according to an embodiment. FIG. 7C introduces y and C. The y can represent an 1-dimensional output vector that can be determined by applying the C mapping function to the state vector (e.g., x(k)). The C mapping function can represent a mapping that the current state has on the output vector. For example, in one embodiment, the output vector, y(k) can be defined as follows: y(k)=T_{indoor}(k). In other words, in this embodiment, y(k) is the predicted internal temperature of enclosure 710. In another example. FIG. 7E shows that y(k) can represent outputs for different devices 721-724 located in the actual enclosure 720 being modeled by state space model of enclosure 710.

FIG. 7D shows yet another illustrative schematic showing another portion of the state-space model that builds on the schematic of FIG. 7C, according to an embodiment. FIG. 7D introduces yₘₑₐₛ(k), e(k) and mapping function K. Yₘₑₐₛ(k) can represent actual measured values obtained from one or more sensors located within enclosure 710. For example, yₘₑₐₛ(k) can represent temperature and humidity sensor readings from one or more of thermostats and/or smoke detectors located in the enclosure. FIG. 7E shows, for example, that devices 721-724 are providing measurement data. Correction factor e(k) represent the difference between y(k) and yₘₑₐₛ(k). K represents a mapping that the correction factor e(k) has on updating the next internal state (x(k+1)) of enclosure 710.

The mapping functions A, B, C, and K can represent sub-space parameters that may be calculated by the thermodynamic state-space engine according to various embodiments on a periodic basis (e.g., once a day). The state-space engine may make assumptions that correlations exist between inputs and outputs (e.g., an HVAC input will affect temperature and humidity within the enclosure) so that the sub-space parameters (e.g., A, B, C, and K mapping functions) can be calculated. When the sub-space parameters are found, the state-space engine can determine that predicted outputs, y(k) and the next state space x(k+1) can be calculated.

One of the advantages of the thermal model defined by the state-space described in connection with FIGS. 7A-7D is that no model changes are required for enclosures having multiple zones. For example, if additional zones are added to the enclosure, the B and C mappings may be updated to incorporate the additional inputs and the thermal model will automatically incorporate the new factors. There is no need to create additional new models for the new factors. Another advantage is that regardless of how many new inputs and sensors are added to the enclosure, the thermal model can rapidly assimilate the changes and accurately predict the temperature. For example, FIG. 7F, shows that even when new devices 731 and 732 are added to enclosure 720, the state-space model can create new entries for the devices in the Y(k) and Yₘₑₐₛ(k) vectors, while maintaining the same state-space vector, x. The state-space vector will, however, take the new Y(k) and Yₘₑₐₛ(k) vector entries into account (by way of the e vector) as it updates over time.

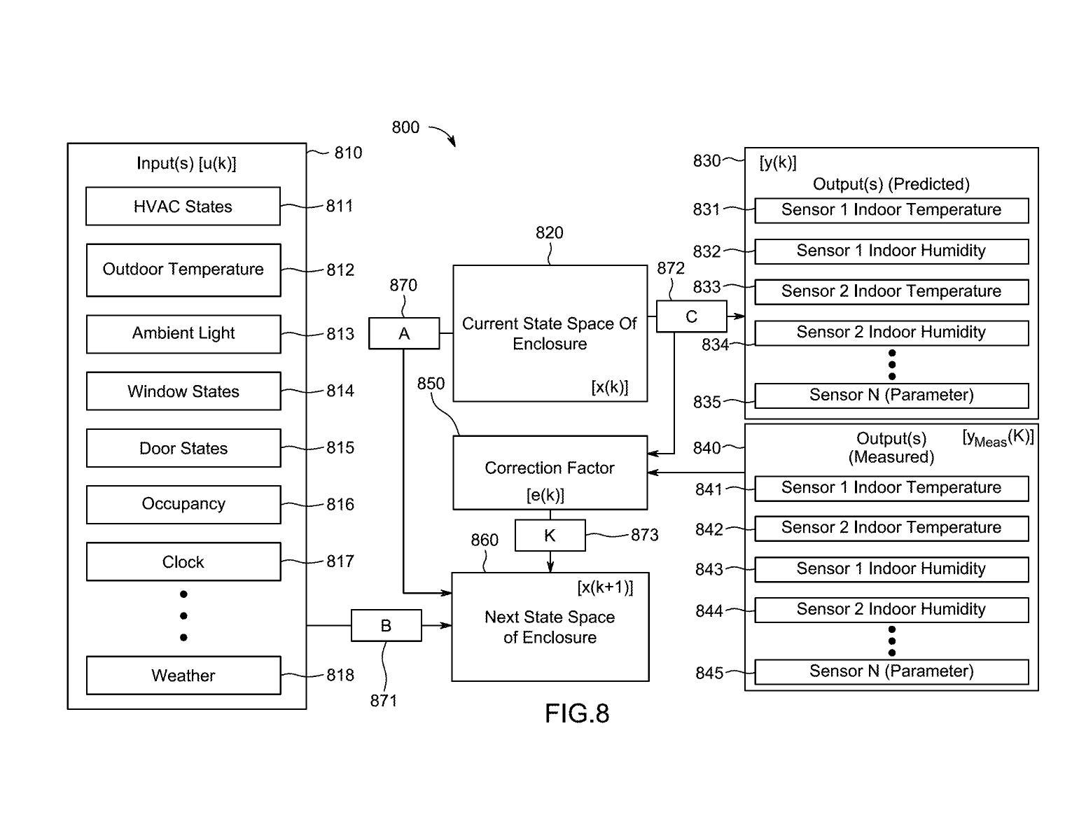

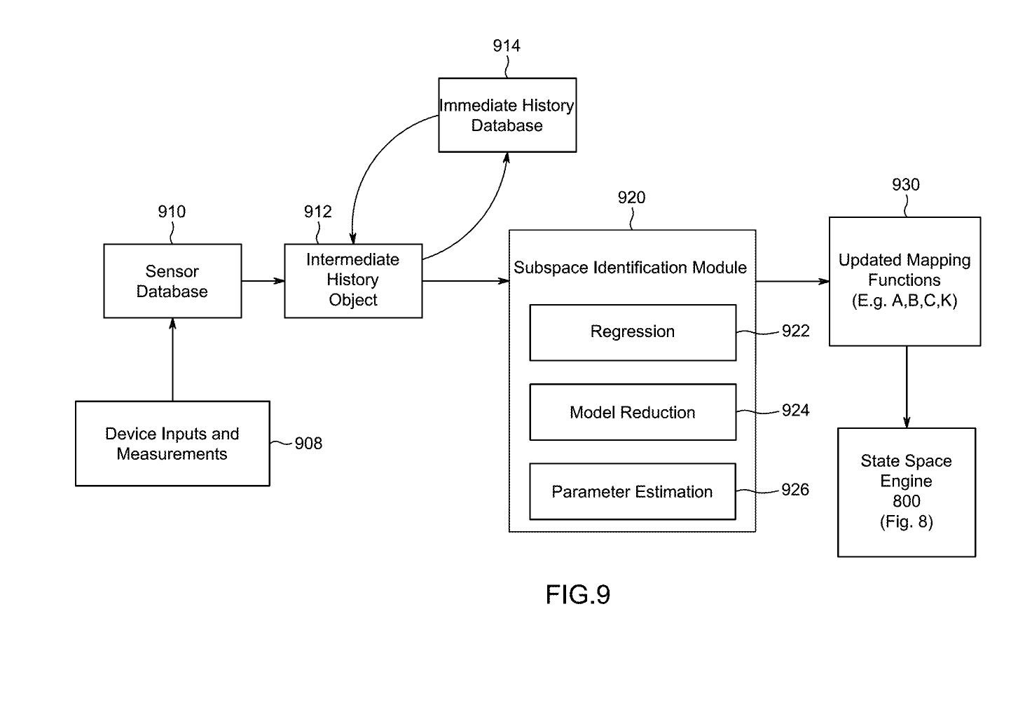

FIG. 8 shows an illustrative schematic representation of state-space model 800 according to an embodiment. State-space model 800 can include inputs 810, current state space 820, predicted outputs 830, measured outputs 840, correction factor 850, and next state space 860. State-space model 800 also includes A mapping function 870, which exists between current state space 820 and next state space 860, B mapping function 871, which exists between inputs 810 and next state space 860, C mapping function 872, which exists between current state space 820 and predicted outputs 830, and K mapping function 873, which exists between correction factor 850 and next state space 860.

Inputs 810 can represent various factors that can affect the thermodynamic characteristics of an enclosure. The inputs can include, for example, HVAC states 811, outdoor temperature 812, ambient light 813, window states 814, door states 815, occupancy 816, clock 817, and weather 818. It should be understood that any additional inputs can be added and any inputs listed herein can be omitted. HVAC states 811 can represent all the different possible HVAC operational states that can be imposed on the enclosure (e.g., single stage, dual stage, dual stage and auxiliary pump, etc.). Outdoor temperature 812 can represent the temperature outside of the enclosure. Ambient light 813 can represent how much ambient light is striking the enclosure. Window and door states 814 and 815 may represent whether windows and doors are open or closed. Occupancy 816 can indicate whether any persons are present or expected to be present. Clock 817 can include calendar and time of day information. Weather 818 can indicate current conditions (e.g., temperature, humidity, wind, etc.) and predicted conditions.

Current state-space 820, correction factor 850, and next state-space 860 have been discussed above and require no further explanation.

Predicted outputs 830 can represent various predicted outputs generated by state-space model 800. Any suitable number of outputs may be generated. If desired, multiple outputs can be generated for each sensor/device. For example, as shown, outputs 831 and 833 may represent predicted indoor temperature for sensors 1 and 2, respectively, and outputs 832 and 834 may represent predicted indoor humidity for sensors 1 and 2, respectively. Output 835 may represent a predicted parameter for sensor N. For example, sensor 1 can be a thermostat, sensor 2 can be smoke detector, and sensor N can be a central alarm system. Each of the sensors can be located in different regions or zones of the enclosure, thereby providing a basis for thermal model 800 to map and predict parameters at those different zones.

Measured outputs 840 can represent actual measured data acquired from one or more sensors located within the enclosure. The measured outputs can match predicted outputs, or the measured outputs can be less than or greater than the number of predicted outputs. As illustrated in this FIG., the measured outputs match those of the predicted outputs. As such, outputs 841 and 843 may represent measured indoor temperature acquired at sensors 1 and 2, respectively, and outputs 842 and 844 may represent indoor humidity acquired at sensors 1 and 2, respectively. Measured output 845 may represent a parameter acquired by sensor N.

Mapping functions 870-873 can represent the variables used by thermal model 800 to ascertain the predicted outputs and the next state space. Over time, one or more of mapping functions 870-873 may change as new training data (e.g., measured outputs) is acquired. Mapping functions 870-873 may be updated on a periodic basis (e.g., once a day, every four hours, once a week, etc.). The manner by which mapping functions 870-873 are updated is discussed below in more detail. It should be appreciated that the mapping functions are used to solve x(k+1) and y(k) of the state space model.

The state space model can be represented by different mathematical representations that may enable state space model engine 800 to estimate values of the next state space and the outputs. These alternative representations of the state space are now discussed. The state space system can be represented in a predictor form:

x(k+1)=A_{K}x(k)+B_{K}z(k),

y(k)=Cx(k)+e(k),

where:

z(k)=[u(k)^{T}y(k)^{T}]^{T},

A_{K}=A−KC,

B_{K}=[BK].

Based on this representation, an extended state-space model can be formulated as:

$${Y}_{s , s , N} = {Γ}_{s} {X}_{s , N} + {H}_{s} {U}_{s , s , N} + {G}_{s} {E}_{s , s , N} , \\ where \text{:}$$

$${Y}_{s , s , N} = [ \begin{matrix}y ( s ) & y ( s + 1 ) & … & y ( N + s - 1 ) \\ y ( s + 1 ) & y ( s + 2 ) & … & y ( N + s ) \\ ⋮ & ⋮ & ⋱ & ⋮ \\ y ( 2 s - 1 ) & y ( 2 s ) & … & y ( N + 2 s - 2 )\end{matrix} ] ∈ {ℝ}^{sl \times N} , \\ {X}_{s , N} = [ \begin{matrix}x ( s ) & x ( s + 1 ) & … & x ( N - 1 )\end{matrix} ] ∈ {ℝ}^{n \times N} , \\ {U}_{s , s , N} = [ \begin{matrix}u ( s ) & u ( s + 1 ) & … & u ( N + s - 1 ) \\ u ( s + 1 ) & u ( s + 2 ) & … & u ( N + s ) \\ ⋮ & ⋮ & ⋱ & ⋮ \\ u ( 2 s - 1 ) & u ( 2 s ) & … & u ( N + s - 1 )\end{matrix} ] ∈ {ℝ}^{sm \times N} , \\ {E}_{s , s , N} = [ \begin{matrix}e ( s ) & e ( s + 1 ) & … & u ( N + 2 s - 2 ) \\ e ( s + 1 ) & e ( s + 2 ) & … & e ( N + s ) \\ ⋮ & ⋮ & ⋱ & ⋮ \\ e ( 2 s - 1 ) & e ( 2 s ) & … & e ( N + 2 s - 2 )\end{matrix} ] ∈ {ℝ}^{sl \times N} , \\ {Γ}_{s} = [ \begin{matrix}C \\ CA \\ {CA}^{2} \\ ⋮ \\ {CA}^{s - 1}\end{matrix} ] ∈ {ℝ}^{sl \times n} , \\ {H}_{s} = [ \begin{matrix}0 & 0 & 0 & … & 0 \\ CB & 0 & 0 & … & 0 \\ CAB & CB & 0 & & 0 \\ ⋮ & & ⋱ & ⋱ & \\ {CA}^{s - 2} B & {CA}^{s - 3} B & … & CB & 0\end{matrix} ] ∈ {ℝ}^{sl \times sm} , \\ {G}_{s} = [ \begin{matrix}I & 0 & 0 & … & 0 \\ CK & I & 0 & … & 0 \\ CAK & CK & 0 & & 0 \\ ⋮ & & ⋱ & ⋱ & \\ {CA}^{s - 2} K & {CA}^{s - 3} K & … & CK & I\end{matrix} ] ∈ {ℝ}^{sl \times sl} .$$

The value of s can be chosen to represent a level of complexity or length of dynamics to be captured by the state space. In some embodiments, s can be defined as a function (e.g., a multiple of a fixed number) of the order of the state space model. As a specific illustrative example, s can be defined as two times the order model. Thus, if the order of the model is 5, s is 10.

Yₛ, Uₛ, and Eₛ are known, but Xₛ, Γₛ, Hₛ, and Gₛ are not known. Specifically, the Kalman state X_{s,N} is unknown, but the Kalman state can be estimated from past input and output data, and can be represented as:

$${X}_{s , N} = {A}_{k}^{s} {X}_{0 , s} + {L}_{s} [ \begin{matrix}{Y}_{0 , s , N} \\ {U}_{0 , s , N}\end{matrix} ] \approx {L}_{s} [ \begin{matrix}{Y}_{0 , s , N} \\ {U}_{0 , s , N}\end{matrix} ] , \\ where \text{:}$$

$${Y}_{0 , s , N} = [ \begin{matrix}y ( 0 ) & y ( 1 ) & … & y ( N - 1 ) \\ y ( 1 ) & y ( 2 ) & … & y ( N ) \\ ⋮ & ⋮ & ⋱ & ⋮ \\ y ( s - 1 ) & y ( s ) & … & y ( N + s - 2 )\end{matrix} ] ∈ {ℝ}^{sl \times N} , \\ {U}_{0 , s , N} = [ \begin{matrix}u ( 0 ) & u ( 1 ) & … & u ( N - 1 ) \\ u ( 1 ) & u ( 2 ) & … & u ( N ) \\ ⋮ & ⋮ & ⋱ & ⋮ \\ u ( s - 1 ) & u ( s ) & … & u ( N + s - 2 )\end{matrix} ] ∈ {ℝ}^{sm \times N} , \\ {\overline{L}}_{s} = [ \begin{matrix}{A}_{K}^{s - 1} K & {A}_{K}^{s - 2} K & … & K \vert {A}_{K}^{s - 1} B & {A}_{K}^{s - 2} B & … & B\end{matrix} ] ∈ {ℝ}^{n \times s ( l + m )} .$$

An assumption can be made that A_{K}s=0 when A_{K} is stable and s is sufficiently large. Based on this assumption, the extended state space model can be formulated as:

$${Y}_{s , s , N} = {Γ}_{s} {\overline{L}}_{s} [ \begin{matrix}{Y}_{0 , s , N} \\ {U}_{0 , s , N}\end{matrix} ] + {H}_{s} {U}_{s , s , N} + {G}_{s} {E}_{s , s , N} , \\ where \text{:}$$

$${Y}_{P} = {Y}_{0 , s , N} , {Y}_{f} = {Y}_{s , s , N} , \\ {U}_{P} = {U}_{0 , s , N} , {U}_{f} = {U}_{s , s , N} , \\ {E}_{P} = {E}_{0 , s , N} , {E}_{f} = {E}_{s , s , N} , \\ {W}_{P} = [ \begin{matrix}{Y}_{P} \\ {U}_{P}\end{matrix} ] , \\ {L}_{w} = {Γ}_{s} {\overline{L}}_{s} ,$$

This can result in the following formulation of the extended state space model:

Y_{f}=L_{w}Wₚ+HₛU_{f}+GₛE_{f}.

FIG. 9 shows an illustrative schematic diagram illustrating mapping function determination engine 900 of how mapping functions are updated according to an embodiment. Mapping function determination engine 900 can include device inputs and measurements 908, sensor database 910, intermediate history object 912, intermedia history database 914, subspace identification module 920, updated mapping functions 930, and state space engine 800. Determination engine 900 can be run on a periodic basis in order to ascertain updated mapping functions 870-873. For example, the periodic basis can be any suitable time frame such as once a day, twice a day, six times a day, or once a week. The frequency at which determination engine 900 may determine how fast newly acquired sensor data and inputs are used for ascertaining the mapping functions. In some embodiments, determination engine 900 can throttle the periodic basis as needed. For example, when evidence of a new input or a new sensor is provided, determination engine 900 may temporarily increase the frequency during which it ascertains updated mapping functions. This may permit the new data to be more quickly assimilated into the state-space model. After a relative steady state has been achieved, the frequency of updates may return back to its “normal” period.

Device inputs and measurements 908 may represent data points that are collected and stored in sensor database 910 on a period basis. The period basis for data collection can be, for example, one a minute, every five minutes, or any other suitable timeframe. In some embodiments, some the data collection rate may vary depending on the type of device. For example, thermostat devices may have a different data collection rate than a smoke detector device or security monitoring device. Device inputs can represent inputs provided by the device. For example, for thermostat devices, the input can be HVAC control instructions (e.g., run-time, setpoints, etc.). In other embodiments, the device inputs can include one or more of the inputs provided to the state-space model (e.g., one or more of inputs 811-818). The measurements can be data measured by a device located within the enclosure. For example, a thermostat may measure the temperature at its location. In some embodiments, the measurements can include one or more of the same measurements that are used in the state-space model (e.g., outputs 841-845).

Sensor database 910 can function as a cache for temporarily storing device inputs and measurements. Sensor database 910 can accumulate data during the periodic basis set by the determination engine 900. Thus, if the periodic basis is one day, sensor database 910 accumulates data for a day, and after the day is over, the accumulated data is provided to subspace identification module 920, and the data stored in database 910 is flushed. New data can be collected and stored during the next periodic cycle.

Intermediate history database 914 can store a state-space model representation of an intermediate history object 912 that includes all previously acquired sensor data with a bias that puts less emphasis on older data. The intermediate history object maintains a fixed size regardless of how much data acquired and is updated each time accumulated data is provided by sensor database 910. The intermediate history object 912 provided to subspace identification 920 can incorporate the new sensor data (as being provided by sensor data base 910). The new sensor data is incorporated into the intermediate history object provided by intermediate history database 914. More particularly, the intermediate history object is updated in a recursive manner that only uses the new data to update the object. The recursive updating nature of the intermediate history block provides an advantage for enabling the state-space model to rapidly adapt to monitored changes in the enclosure. In addition, each recursive update of the intermediate history object is stored in intermediate history database 914. Moreover, as will be explained in more detail below, the intermediate history object is maintained the same format (e.g., LQ factorization) used by one of the subspace identification processes implemented by subspace identification module 920. This format can be the result of a least squares regression, for example.

Subspace identification module 920 can receive intermediate history database 912, which incorporates new sensor data provided by sensor databased 910 and the history object stored in history database 914. Using the updated intermediate history object 912, subspace identification module 920 can calculate updated mapping functions by processing the data in regression engine 922, model reduction engine 924, and parameter estimation engine 926. The updated mapping functions obtained from module 920 are represented by box 930. Updated mapping functions 930 are provided to engine 800 to evaluate state space and output determinations using the updated mapping functions.

Subspace identification module 920 may calculate the updated mapping functions by performing the following steps in order: regression, model reduction, and parameter estimation. Regression engine 922 may perform a least squares regression to estimate one or several high-order models. Regression engine 922 can computer the least squares estimates in the following equation:

$$[ \begin{matrix}{\hat{L}}_{w} & {\hat{H}}_{s}\end{matrix} ] = {{Y}_{f} [ \begin{matrix}{W}_{P} \\ {U}_{f}\end{matrix} ]}^{†} ,$$

where [•]^{†} is a Moore-Penrose pseudo-inverse. This equation can be solved by examining the following LQ decomposition:

$$\frac{1}{\sqrt{( j )}} [ \begin{matrix}{U}_{P} \\ {U}_{f} \\ {Y}_{P} \\ {Y}_{f}\end{matrix} ] = \frac{1}{\sqrt{( j )}} [ \begin{matrix}U \\ Y\end{matrix} ] = LQ = [ \begin{matrix}{L}_{11} & 0 & 0 & 0 & 0 & 0 \\ {L}_{21} & {L}_{22} & 0 & 0 & 0 & 0 \\ {L}_{31} & {L}_{32} & {L}_{33} & 0 & 0 & 0 \\ {L}_{41} & {L}_{42} & {L}_{43} & {L}_{44} & 0 & 0 \\ {L}_{51} & {L}_{52} & {L}_{53} & {L}_{54} & {L}_{55} & 0 \\ {L}_{61} & {L}_{62} & {L}_{63} & {L}_{64} & {L}_{65} & {L}_{66}\end{matrix} ] [ \begin{matrix}{Q}_{1} \\ {Q}_{2} \\ {Q}_{3} \\ {Q}_{4} \\ {Q}_{5} \\ {Q}_{6}\end{matrix} ] , \\ where j = N - 2 s + 1 and {L}_{11} ∈ {ℝ}^{m s \times m s} , {L}_{22} ∈ {ℝ}^{m \times m} , \\ {L}_{33} ∈ {ℝ}^{m ( s - 1 ) \times m ( s - 1 )} , {L}_{44} ∈ {ℝ}^{ls \times ls} , {L}_{55} ∈ {ℝ}^{l \times l} , {L}_{66} ∈ {ℝ}^{l ( s - 1 ) \times l ( s - 1 )} .$$

The LQ decomposition of a matrix A can be derived from the QR decomposition as follows:

Q_{R}R=A^{T},

S=diag(sgn(diag(R))).

L=(S⁻¹R),T,

Q_{L}=(Q_{R}S),T,

LQ_{L}=A.

Regression engine 922 may create an intermediate block, L_{w}, represented by the following equation:

L_{w}=[(L_{U}_{_{P}}L_{[1:1],[1:3]}+L_{Y}_{_{P}}L_{[4:4],[1:3]})ΠL_{Y}_{_{P}}L₄₄]ε [symbol] ^{1s×(2m+1)s},

where

[(L_{U}_{_{P}}L_{U}_{_{f}}L_{Y}_{_{P}}]=L_{[5:6],[1:4]}L_{[1:4],[1:1]}^{†}εε [symbol] ^{1s×(2m+1)s},

Π=I₂ₘₛ−L_{[2:3],[1:3]}^{T}(L_{[2:3],[1:3]}L_{[2:3],[1:3]})⁻¹L_{[2:3],[1:3]}ε [symbol] ^{2ms×2ms},

After the intermediate block, L_{w}, is obtained, model reduction engine 924 reduces it to an appropriate low dimensional subspace that is observable. In other words, model reduction engine 924 reduces the intermediate block to a lower order intermediate block. For example, the intermediate block, L_{w}, can be factorized using a Singular Value Decomposition (SVD). An SVD factorization of can be represented by the following equation:

L_{w}=δₛ^{̂}\tilde{L}ₛ≈UₙSₙVₙ^{T},

where Uₙ, Sₙ, and Vₙ are associated with the n largest singular values. δs can be chosen to be represented by the following equation:

\hat{Γ}ₛ=UₙSₙ^{1/2},

which enables parameter estimation engine 926 to estimate mapping functions A and C.

Parameter estimation engine 926 can estimate the mapping functions from the lower order intermediate block. Parameter estimation engine 926 may first solve mapping functions A and C. Once mapping functions A and C are found, engine 926 may solve for mapping function B, and then mapping functions K and R can be found. Mapping function R may represent noise in the data.

Parameter estimation engine 926 can estimate mapping functions A and C by defining the following two matrices:

$${𝒯}_{l} = [ \begin{matrix}{\hat{Γ}}_{s - 1}^{†} {L}_{[ 6 : 6 ] , [ 1 : 5 ]} \\ {L}_{[ 5 : 5 ] , [ 1 : 5 ]}\end{matrix} ] ∈ {ℝ}^{l + n \times ( 2 m + l ) s + 1} , \\ {𝒯}_{r} = [ \begin{matrix}{\hat{Γ}}_{s - 1}^{†} {L}_{[ 5 : 6 ] , [ 1 : 5 ]} \\ {L}_{[ 2 : 3 ] , [ 1 : 5 ]}\end{matrix} ] ∈ {ℝ}^{m s + n \times ( 2 m + l ) s + 1} .$$

Mapping functions A and C can be computed as the first n of

S=T₁Tᵣ^{†}ε [symbol] ^{1+n×ms+n}.

Parameter estimation engine 926 can solve mapping function B defining the following matrices:

$$𝒫 = {𝒯}_{l} - [ \begin{matrix}A \\ C\end{matrix} ] {\hat{Γ}}_{s}^{†} {L}_{[ 5 : 6 ] , [ 1 : 5 ]} ∈ {ℝ}^{l + n \times ( 2 m + l ) s + 1} , \\ 𝒬 = {L}_{[ 2 : 3 ] , [ 1 : 5 ]} ∈ {ℝ}^{m s \times ( 2 m + l ) s + 1} , \\ {𝒩}_{1} = [ \begin{matrix}{ℳ}_{1} - {ℒ}_{1 \vert 2} & {ℳ}_{2} - {ℒ}_{1 \vert 3} & … & {ℳ}_{s - 1} - {ℒ}_{1 \vert s} \\ - {ℒ}_{2 \vert 2} & - {ℒ}_{2 \vert 3} & … & - {ℒ}_{2 \vert s}\end{matrix} ] {\hat{Γ}}_{s - 1} ∈ {ℝ}^{n + l \times n} , \\ {𝒩}_{1} = [ \begin{matrix}{ℳ}_{2} - {ℒ}_{1 \vert 3} & {ℳ}_{3} - {ℒ}_{1 \vert 4} & … & 0 \\ - {ℒ}_{2 \vert 3} & - {ℒ}_{2 \vert 4} & … & 0\end{matrix} ] {\hat{Γ}}_{s - 1} ∈ {ℝ}^{n + l \times n} , \\ ⋮ \\ {𝒩}_{s} = [ \begin{matrix}{ℳ}_{s - 1} - {ℒ}_{1 \vert s} & 0 & … & 0 \\ - {ℒ}_{2 \vert s} & 0 & … & 0\end{matrix} ] {\hat{Γ}}_{s - 1} ∈ {ℝ}^{n + l \times n} , \\ where \text{:} \\ ℒ = [ \begin{matrix}A \\ C\end{matrix} ] {\hat{Γ}}_{s}^{†} = [ \begin{matrix}{ℒ}_{1 \vert 1} & {ℒ}_{1 \vert 2} & … & {ℒ}_{1 \vert s} \\ {ℒ}_{2 \vert 1} & {ℒ}_{2 \vert 2} & … & {ℒ}_{2 \vert s}\end{matrix} ] ∈ {ℝ}^{l + n \times ls} , \\ ℳ = {\hat{Γ}}_{s - 1}^{†} = [ \begin{matrix}{ℳ}_{1} & {ℳ}_{2} & … & {ℳ}_{s - 1}\end{matrix} ] ∈ {ℝ}^{n \times l ( s - 1 )} . \qquad$$

After the matrices are defined, parameter estimation engine 926 can solve the least squares equation to find the B mapping function:

vec(\hat{B})=(Σₖ₌₁^{s}Qₖ^{T} [symbol] Nₖ)^{†}vec(p).

Parameter estimation engine 926 may estimate mapping functions K and R by the following covariance matrices:

$$[ \begin{matrix}Q & S \\ {S}^{T} & R\end{matrix} ] = ( {𝒯}_{l} - S {𝒯}_{r} ) {( {𝒯}_{l} - S {𝒯}_{r} )}^{T} .$$

These matrices can be used to find a steady-state Kalman filter based observer (K) by solving a Discrete Algebraic Ricatti Equation (DARE).

After the mapping functions are found by subspace module 920, state space model with updated mapping functions 930 may update the intermediate history object and provide it to intermediate history database 940. This can be done by assuming that a solution exists to the LQ factorization, represented as:

$$\frac{1}{\sqrt{{j}_{k}}} [ \begin{matrix}{U}_{k} \\ {Y}_{k}\end{matrix} ] = {L}_{k} {Q}_{k} .$$

The new sensor data can be added to the old intermediate history object in the following collation:

$$[ \begin{matrix}β \frac{1}{\sqrt{{j}_{k}}} [ \begin{matrix}{U}_{k} \\ {Y}_{k}\end{matrix} ] & \frac{1}{\sqrt{{j}_{[ k , k + 1 )}}} [ \begin{matrix}{U}_{[ k , k + 1 )} \\ {Y}_{[ k , k + 1 )}\end{matrix} ]\end{matrix} ] = [ \begin{matrix}β {L}_{k} & \frac{1}{\sqrt{{j}_{[ k , k + 1 )}}} [ \begin{matrix}{U}_{[ k , k + 1 )} \\ {Y}_{[ k , k + 1 )}\end{matrix} ]\end{matrix} ] [ \begin{matrix}{Q}_{k} & 0 \\ 0 & I\end{matrix} ] = {L}_{k + 1} {Q}_{k + 1} [ \begin{matrix}{Q}_{k} & 0 \\ 0 & I\end{matrix} ] ,$$

where βε[0,1] is a forgetting factor that puts less emphasis on older data. The new Lₖ₊₁ is provided to intermediate history database 940 for storage as the updated intermediate history object.

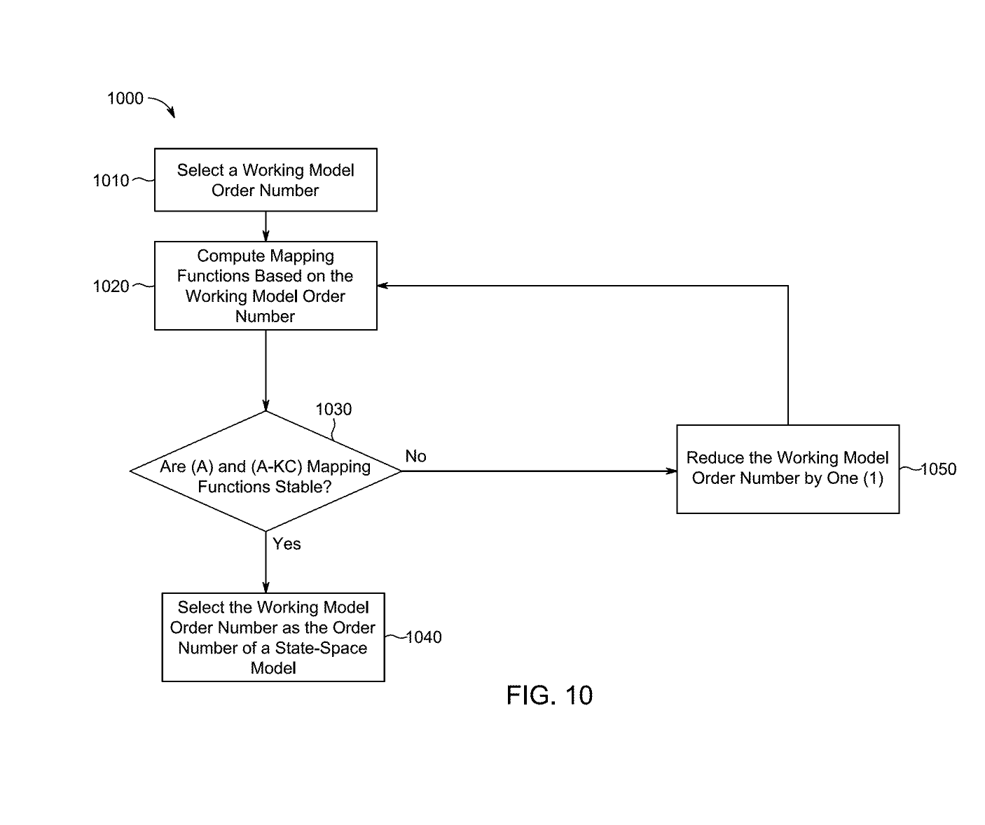

FIG. 10 shows an illustrative flowchart for selecting an order for the state-space model according to an embodiment. Process 1000 may begin at step 1010 by selecting a working model order number. This selected working order number can be any suitable number, where the larger the order number can represent modeling of increasing complexity. At step 1020, the mapping functions (e.g., one or more of A, B, C, K) can be computed based on the working model order number. These mapping functions may be computed using the techniques described above, for example. At step 1030, a determination is made whether the A mapping function is stable and whether the difference between the A mapping function and the product of the K and C mapping functions (A-KC) is stable. A mapping function may be considered stable if all or substantially all of its eigenvalues exist within a unit circle. If the determination at step 1030 is YES, process 1000 can select the working order number as the order number of the state-space model. If the determination at step 1040 is NO, process 1000 may decrease the working order number by one, as step 1050. After the working order number is decreased, process 1000 reverts back to step 1020 to repeat steps 1020 and 1030.

It should be understood that the steps shown in FIG. 10 are merely illustrative and that additional steps may be added, re-arranged, or omitted. For example, if the working order number has been reduced to the number two, and no stable model number has been found, a default order number (e.g., 1) may be selected.

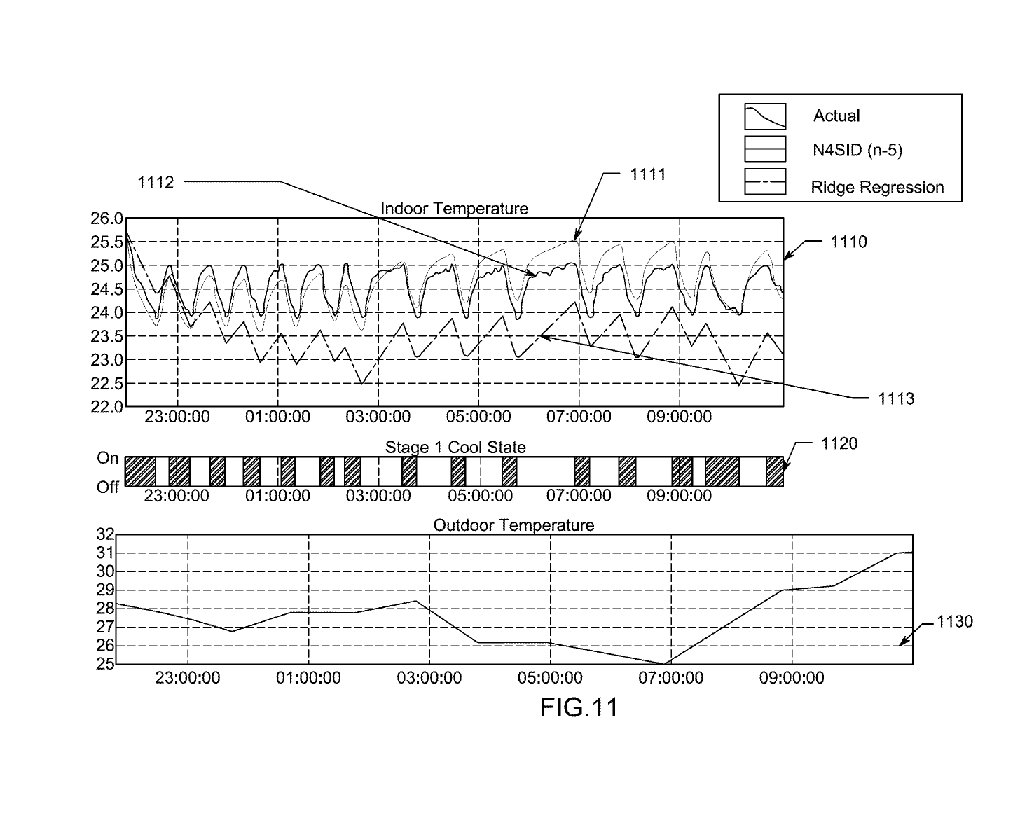

FIG. 11 shows different illustrative graphs showings model inputs, model outputs, and actual measured indoor temperature based on a test using the thermodynamic state-space model according to embodiment. Graph 1110 shows indoor temperatures for actual measured temperature within an enclosure (shown by waveform 1111), predicted temperature generated by the thermodynamic state-space model according to embodiments described herein (shown by waveform 1112), and predicted temperature generated by a conventional ridge regression model (shown by waveform 1113). Graph 1120 shows HVAC cooling stage ON and OFF times, and graph 1130 shows outdoor temperatures, both of which represent inputs to the models. The results show that state-space model waveform 1112 more closely approximates actual values of waveform 1111 than conventional ridge regression model waveform 1113.

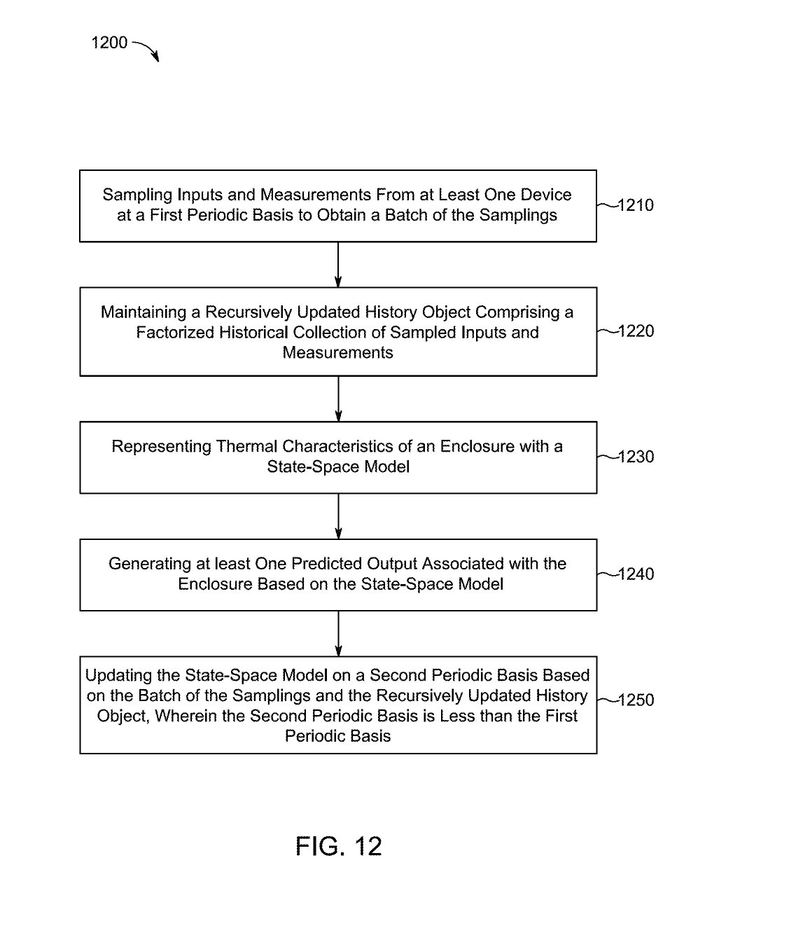

FIG. 12 shows an illustrative process 1200 for modeling characteristics of an enclosure. Starting at step 1210, inputs and measurements from at least one device are sampled at a first periodic basis to obtain a batch of the samplings. For example, one or more devices within the enclosure may sample sensor readings and/or input once a minute. At step 1220, a recursively updated history object including a historical collection of sampled inputs and measurements can be maintained. The history object can be, for example, stored in an intermediate history database 940 of FIG. 9. At step 1230, thermal characteristics of the enclosure can be represented with a state-space model according to embodiments discussed herein. For example, the state-space model can be represented by x(k), as discussed above. At step 1240, at least one predicted output associated with the enclosure can be generated based on the state-space model. For example, the output can be obtained from y(k), as discussed above. At step 1250, the state-space model can be updated on a second periodic basis based on the batch of the samplings and the recursively updated history object, wherein the second periodic basis is less than the first periodic basis. The second period of time can be, for example, once a day. This way, after a day's worth of samplings is obtained, that batch can be used for updating the state-space model and the recursively updated history object.

It should be understood that the steps shown in FIG. 12 are merely illustrative and that additional steps may be added, re-arranged, or omitted. For example, if the state-space model includes several vectors and mapping functions, wherein each mapping function is associated with a respective one of the vectors, the process can use subspace identification on the batch of the samplings and the recursively updated history object to update the mapping functions.

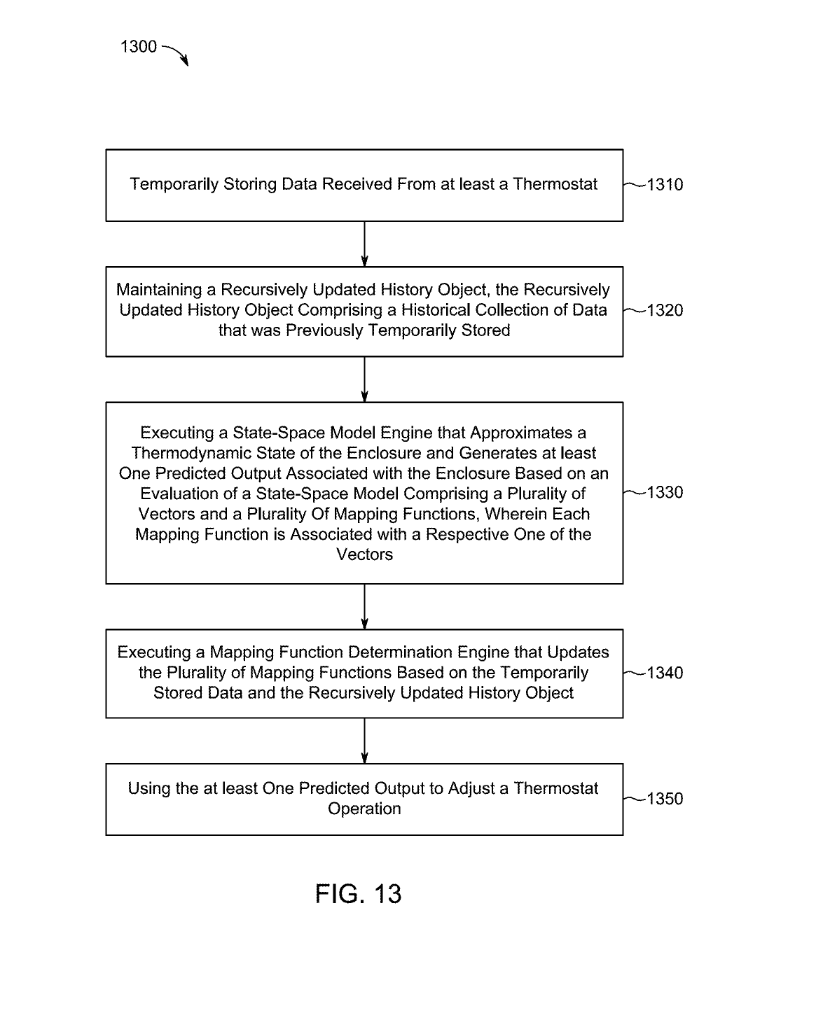

FIG. 13 shows an illustrative process 1300 for using a thermodynamic state-space model of an enclosure that is implemented in a thermostat. At step 1310, data received from at least the thermostat can be temporarily stored. At step 1320, a recursively updated history object can be maintained. The recursively updated history object can include a historical collection of data that was previously temporarily stored. At step 1330, a state-space model engine (e.g., engine 800 of FIG. 8) that approximates a thermodynamic state of the enclosure can be executed to generate at least one predicted output associated with the enclosure based on an evaluation of a state-space model including a several vectors and several mapping functions, wherein each mapping function is associated with a respective one of the vectors. For example, the A mapping function may be associated with the x(k) vector, the B mapping function may be associated with the u(k) vector, the K mapping function may be associated with e(k) vector, and the C mapping function may be associated with the x(k) vector.

A step 1340, a mapping function determination engine (e.g., engine 900 of FIG. 9) that updates the plurality of mapping functions based on the temporarily stored data and the recursively updated history object can be executed. At step 1350, the at least one predicted output can be used to adjust a thermostat operation.

It should be understood that the steps shown in FIG. 13 are merely illustrative and that additional steps may be added, re-arranged, or omitted.

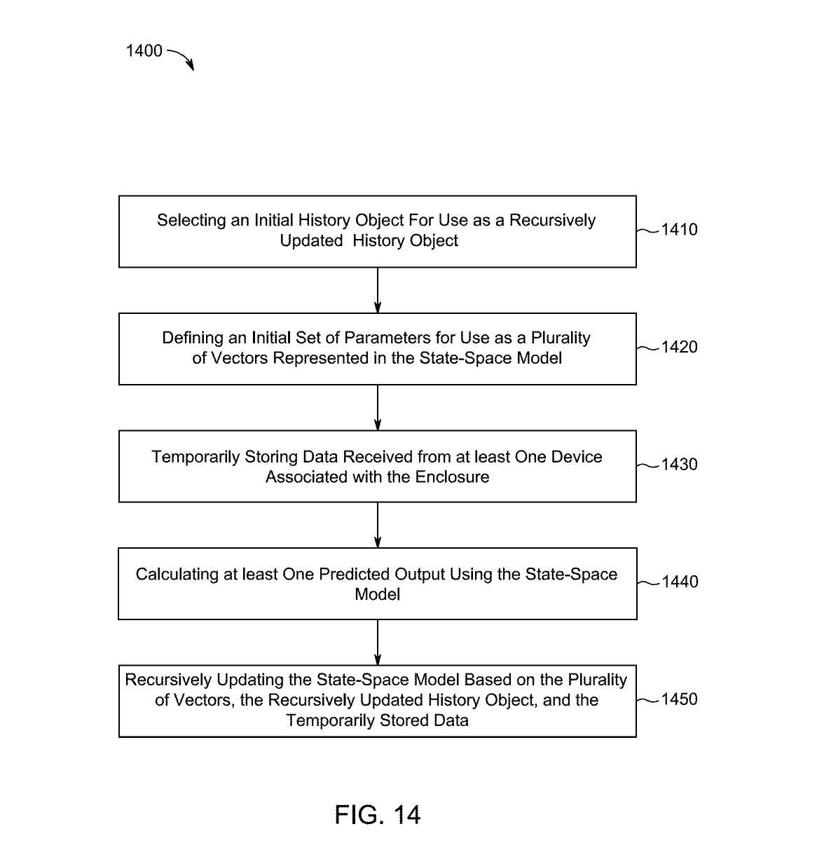

FIG. 14 shows an illustrative process 1400 for controlling a HVAC (heating, ventilation, and air conditioning) system based on a thermodynamic state-space model that characterizes thermal characteristics of an enclosure. Starting at step 1410, an initial history object can be selected for use as a recursively updated history object. For example, if the device is taken out-of-box, the initial history object can be selected based on a geographic location of the device. At step 1420, an initial set of parameters can be defined for use as a plurality of vectors represented in the state-space model. For example, the initial set of parameters may define the inputs and measured outputs for any number of devices currently present in the enclosure. At step 1430, data received from at least one device associated with the enclosure is temporarily stored. At step 1440, at least one predicted output using the state-space model can be calculated. At step 1450, the state-space model can be recursively updated based on the plurality of vectors, the recursively updated history object, and the temporarily stored data.

It should be understood that the steps shown in FIG. 14 are merely illustrative and that additional steps may be added, re-arranged, or omitted.

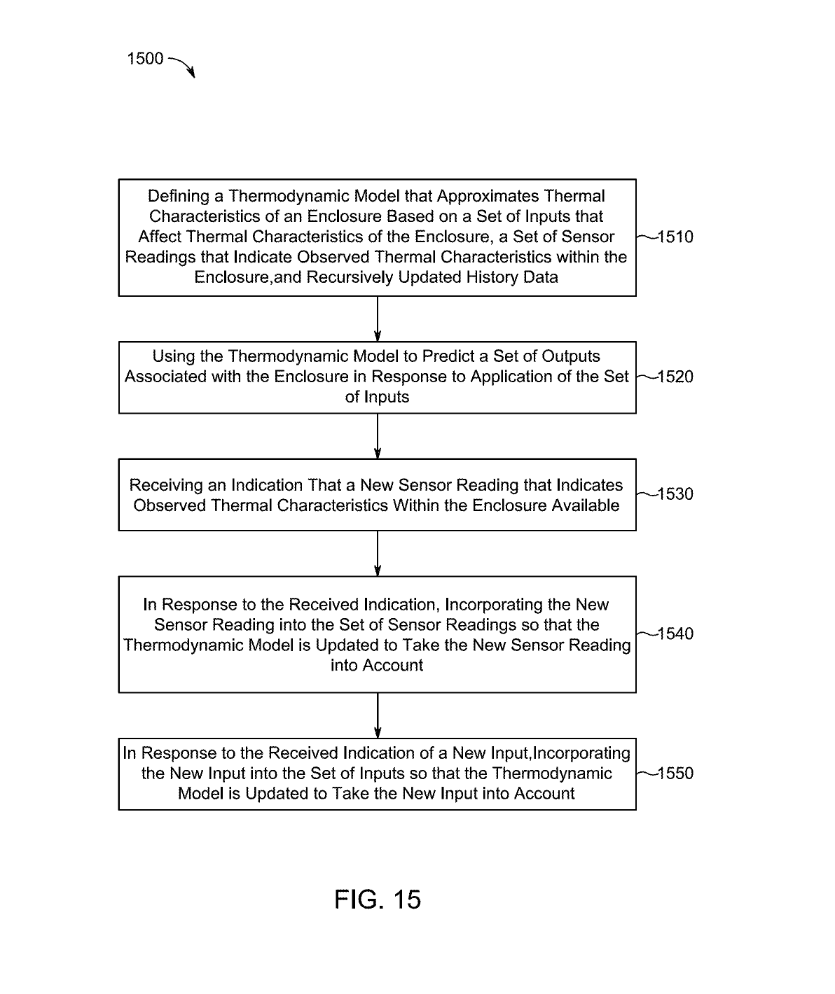

FIG. 15 shows an illustrative process 1500 for controlling a HVAC (heating, ventilation, and air conditioning) system. The process can be implemented in a thermostat. At step 1510, a thermodynamic model that approximates thermal characteristics of an enclosure can be defined based on a set of inputs that affect thermal characteristics of the enclosure, a set of sensor readings that indicate observed thermal characteristics within the enclosure, and recursively updated history data. At step 1520, the thermodynamic model can be used to predict a set of outputs associated with the enclosure in response to application of the set of inputs. At step 1530, an indication is received that a new sensor reading that indicates observed thermal characteristics within the enclosure is available. For example, the user may have installed a new device in the enclosure that provides an input or measured data point. At step 1540, in response to the received indication, the new sensor reading can be incorporated into the set of sensor readings so that the thermodynamic model is updated to take the new sensor reading into account. At step 1550, in response to a received indication of the new input, the new input can be incorporated into the set of inputs so that the thermodynamic model is updated to take the new input into account.

It should be understood that the steps shown in FIG. 15 are merely illustrative and that additional steps may be added, re-arranged, or omitted.

In some embodiments, because the state-space model can accurately represent the thermodynamic operations of an enclosure, any unexpected deviations from an expected output may be captured and analyzed to assess whether a new thermal source (e.g., a heating or cooling source other than known thermal sources such as HVAC) is present. For example, the new thermal source can be a fireplace that operates at select times during the day throughout the year, an open door or window, a humidifier, a fan, an oven, or anything that can affect the thermal characteristics of an enclosure. If a new thermal source is present, but not accounted for in the state space thermal model, the predicted results can vary significantly from the actual results.

The presence of a new thermal source that is not accounted for in the state space model can cause the A mapping function to become unstable. If this happens, the state space model may have to reduce the order to a lower order number to obtain stability. This is undesirable, however, because higher order models can more accurately predict outputs of the enclosure. In order to compensate for unaccounted thermal sources, a new thermal source identification process according to an embodiment may be used to identify potential new thermal sources and incorporate them as inputs of the input vector, u(k), so that higher order models can be used. The thermal source detection process can monitor predicted outputs and actual measure outputs to determine if the difference between the predicted and actual results exceeds a threshold. If the difference between the two exceeds the threshold, a new input may be created for inclusion into the state space model engine to reflect the presence of the new thermal source.

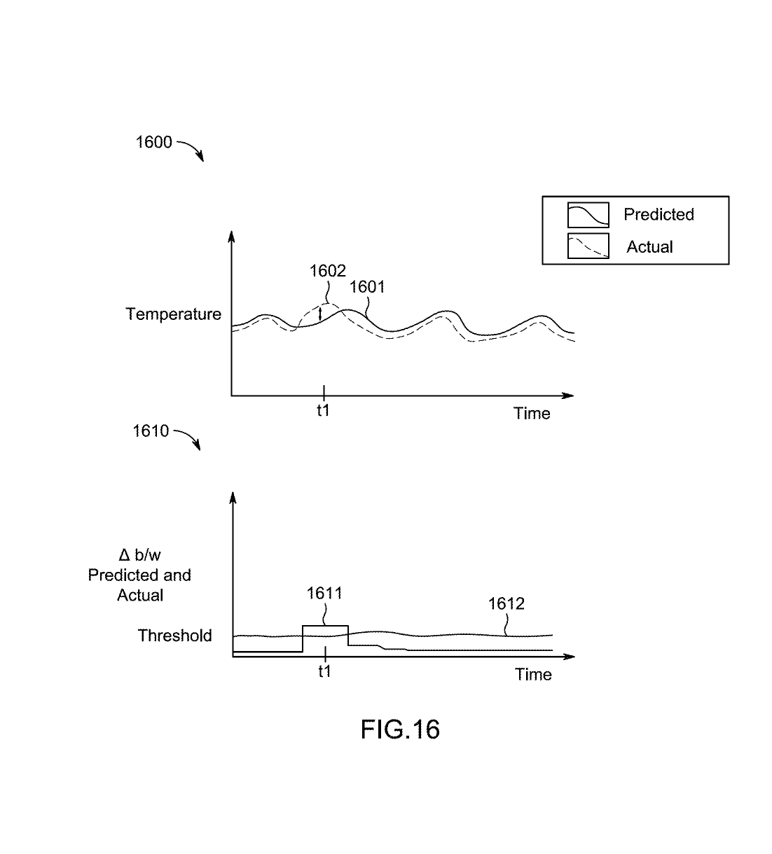

FIG. 16 shows a few illustrative graphs that illustrate how the thermal source detection process can determine whether a new thermal source exists. Graph 1600 shows an illustrative temperature versus time graph that includes predicted temperature waveform 1601 and actual temperature waveform 1602. Predicted waveform 1601 can represent the output generated by the state space model according to various embodiments discussed herein for predicting a temperature within the enclosure. Actual temperature waveform 1602 can represent actual measured temperature within the enclosure. As shown, the predicted and actual waveforms are approximately the same except for time, t1. At time, t1, a noticeable difference between waveforms 1601 and 1602 exists. This represents an instance where the predicted output unexpectedly differs from the actual output.

The difference between the two waveforms is shown in graph 1610. Delta waveform 1611 can represent the difference between the waveforms 1601 and 1602. Any delta that exceeds threshold 1612 can be marked as a possibility of an unaccounted thermal source. As shown, delta waveform 1611 exceeds threshold 1612 at time, t1. The thermal source detection process may monitor this possible new thermal source over a series of cycles and decide whether to create a new input accounting for it. Whether the thermal source detection process creates a new input depends on satisfaction of various criteria. For example, the criteria may include satisfaction of repeated occurrence of the same delta across multiple time periods (e.g., days). Another criterion can be whether incorporation of an input actually eliminates the delta; if it does not, then that input can be discarded.

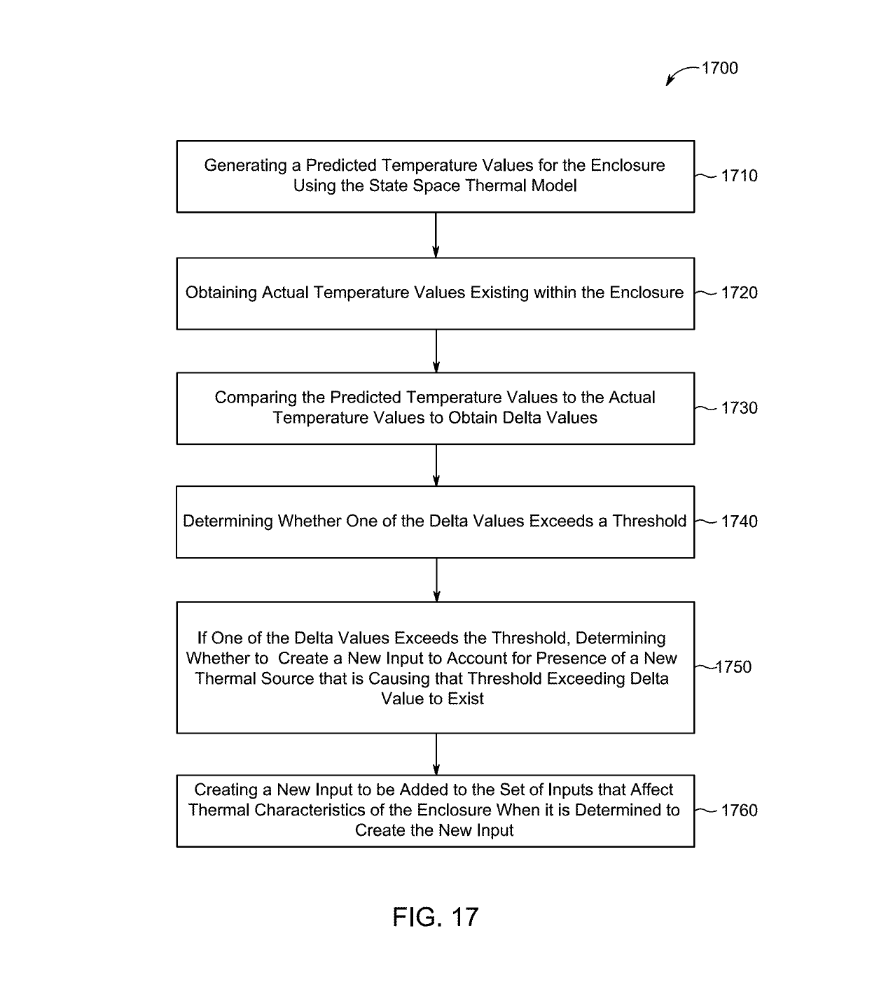

FIG. 17 shows an illustrative process 1700 for detecting new thermal sources according to an embodiment. Process 1700 can use a state-space thermal model that approximates thermal characteristics of an enclosure based on a set of inputs that affect thermal characteristics of the enclosure, a set of sensor readings that indicate observed thermal characteristics within the enclosure, and recursively updated history data to identify unaccounted thermal sources. For example, the state-space thermal model may be similar to the model represented by vector, x(k), as described above. Starting with step 1710, predicted temperature values can be generated for the enclosure using the state-space thermal model. At step 1720, actual temperature values existing within the enclosure are obtained. At step 1730, the predicted temperature values are compared to the actual temperature values to obtain delta values. At step 1740, a determination is made as to whether one of the delta values exceeds a threshold, and if one of the delta values exceeds the threshold, process 1700 determines whether to create a new input to account for presence of a new thermal source that is causing that threshold exceeding delta value to exist (at step 1750). At step 1760, a new input can be created and added to the set of inputs that affect thermal characteristics of the enclosure when it is determined to create the new input.

It should be understood that the steps shown in FIG. 17 are merely illustrative and that additional steps may be added, re-arranged, or omitted.

Whereas many alterations and modifications of the present invention will no doubt become apparent to a person of ordinary skill in the art after having read the foregoing description, it is to be understood that the particular embodiments shown and described by way of illustration are in no way intended to be considered limiting.

1. A device associated with an enclosure, the device comprising:
a sensor database that temporarily stores a batch of device inputs and measurements;
an intermediate history database that stores a recursively updated history object, the recursively updated history object comprising a historical collection of the device inputs and measurements;
control circuitry coupled to the databases and operative to:
execute a state-space model engine that approximates a thermodynamic state of the enclosure and generates at least one predicted output associated with the enclosure based on an evaluation of a state-space model comprising a plurality of vectors and a plurality of mapping functions, wherein each mapping function is associated with a respective one of the vectors; and
execute a mapping function determination engine that updates the plurality of mapping functions based on the batch of device inputs and measurements and the recursively updated history object.

2. The device of claim 1, wherein the batch of device inputs and measurements is obtained from at least one of the device and a remote device.

3. The device of claim 1, wherein the plurality of vectors comprise:
a current state vector that represents the current thermodynamic state-space of the enclosure;
an input vector that represents at least one parameter that has an effect on the thermodynamic characteristics of the enclosure;
an output vector that represents at least one predicted output associated with the enclosure;
a correction factor vector that represents a difference between the output vector and a measured output vector; and
an updated state vector that represents the updated thermodynamic state-space of the enclosure.

4. The device of claim 3, wherein the input vector comprises parameters selected from the group consisting of HVAC states, outdoor temperature, ambient light, window states, door states, occupancy, clock, weather, and any combination thereof.

5. The device of claim 3, wherein the output vector comprises predicted outputs selected from the group consisting of indoor temperature, indoor humidity, and any combination thereof, and wherein the measured output vector comprises measured data selected from the group consisting of indoor temperature, indoor humidity, and any combination thereof.

6. The device of claim 3, wherein the updated state vector is represented by the following equation:
x(k+1)=Ax(k)+Bu(k)+Ke(k)
where x(k+1) is a the updated state vector, A is a mapping function associated with x(k), x(k) is the current state vector, B is a mapping function associated with u(k), u(k) is the input vector, K is a mapping function associated with e(k), and e(k) is the correction factor vector.

7. The device of claim 3, wherein the output vector is represented by the following equation:
y(k)=Cx(k)
where y(k) is the output vector, C is a mapping function associated with x(k), and x(k) is the current state vector.

8. The device of claim 1, wherein the mapping function determination engine:
performs a regression on the batch of device inputs and measurements and the recursively updated history object to estimate a subspace result;
performs model reduction on the subspace result to provide a lower dimensional subspace result; and
performs parameter estimation on the lower dimensional subspace result to calculate the updated mapping functions.

9. The device of claim 1, wherein the control circuitry is operative to:
update the recursively updated history object with the batch of device inputs and measurements and the updated mapping functions.

10. The device of claim 1, wherein the device is a thermostat and the control circuitry is operative to:
adjust a thermostat control function based on the at least one predicted output associated with the enclosure.

11. A method for modeling characteristics of an enclosure, comprising:
sampling inputs and measurements from at least one device at a first periodic basis to obtain a batch of the samplings;
maintaining a recursively updated history object comprising a factorized historical collection of sampled inputs and measurements;
representing thermal characteristics of the enclosure with a state-space model;
generating at least one predicted output associated with the enclosure based on the state-space model; and
updating the state-space model on a second periodic basis based on the batch of the samplings and the recursively updated history object, wherein the second periodic basis is less than the first periodic basis.

12. The method of claim 11, further comprising:
using the at least one predicted output to adjust a thermostat function associated with the enclosure.

13. The method of claim 11, further comprising:
updating the recursively updated history object on the second periodic basis by incorporating a factorized version of the batch of the samplings.

14. The method of claim 11, wherein the state-space model comprises a plurality of vectors and mapping functions, wherein each mapping function is associated with a respective one of the vectors, and wherein a first vector represents the at least one predicted output and a second vector represents an updated version of the state-space model.

15. The method of claim 14, wherein the updating the state-space model comprises:
using subspace identification on the batch of the samplings and the recursively updated history object to update the plurality of mapping functions.

16. The method of claim 15, wherein using subspace identification comprises:
performing least squares regression on the batch of the samplings and the recursively updated history object to estimate an intermediate matrix;
performing model reduction on the intermediate matrix to produce an observable matrix; and
estimating updated versions of the mapping functions based on the observable matrix.

17. The method of claim 14, wherein the second vector is represented by the following equation:
x(k+1)=Ax(k)+Bu(k)+Ke(k)
where x(k+1) is the updated version of the state-space model, A is a mapping function associated with x(k), x(k) is a current state vector, B is a mapping function associated with u(k), u(k) is an input vector, K is a mapping function associated with e(k), and e(k) is a correction factor vector.

18. The method of claim 14, wherein the first vector is represented by the following equation:
y(k)=Cx(k)
where y(k) is the at least one predicted output, C is a mapping function associated with x(k), and x(k) is a current state vector.

19. A method for using a thermodynamic state-space model of an enclosure, the method implemented in a thermostat, the method comprising:
temporarily storing data received from at least the thermostat;
maintaining a recursively updated history object, the recursively updated history object comprising a historical collection of data that was previously temporarily stored;
executing a state-space model engine that approximates a thermodynamic state of the enclosure and generates at least one predicted output associated with the enclosure based on an evaluation of a state-space model comprising a plurality of vectors and a plurality of mapping functions, wherein each mapping function is associated with a respective one of the vectors;
executing a mapping function determination engine that updates the plurality of mapping functions based on the temporarily stored data and the recursively updated history object; and
using the at least one predicted output to adjust a thermostat operation.

20. The method of claim 19, further comprising:
updating the state-space model and the recursively updated history object on a first periodic basis;
receiving the temporarily stored data on a second periodic basis throughout the first periodic basis, wherein the temporarily stored data received during the first periodic basis is incorporated into the recursively updated history object before being flushed.

21. The method of claim 19, wherein the state-space model is the only state-space model maintained for the enclosure.

22. The method of claim 19, wherein executing the mapping function determination engine comprises:
performing a regression on the temporarily stored data and the recursively updated history object to estimate a subspace result;
performing model reduction on the subspace result to provide a lower dimensional subspace result; and
performing parameter estimation on the lower dimensional subspace result to calculate the updated mapping functions.

23. The method of claim 19, wherein the recursively updated history object comprises a forgetting factor de-emphases older stored data.

24. A method for controlling a HVAC (heating, ventilation, and air conditioning) system based on a thermodynamic state-space model that characterizes thermal characteristics of an enclosure, the method comprising:
selecting an initial history object for use as a recursively updated history object;
defining an initial set of parameters for use as a plurality of vectors represented in the state-space model;
temporarily storing data received from at least one device associated with the enclosure;
calculating at least one predicted output using the state-space model; and
recursively updating the state-space model based on the plurality of vectors, the recursively updated history object, and the temporarily stored data.

25. The method of claim 24, further comprising:
updating the recursively updated history object with the temporarily stored data.

26. The method of claim 24, further comprising:
redefining the initial set of parameters to include a new set of parameters for use as the plurality of vectors represented in the state-space model, wherein the new set of parameters are incorporated into the recursively updated state-space model.

27. The method of claim 26, wherein the initial set of parameters comprises parameters associated with a first device, and wherein the new set of parameters comprises parameters associated with the first device and a second device.

28. The method of claim 24, wherein selecting the initial history object is based on a geographic location of the enclosure.

29. The method of claim 24, wherein the recursively updated history object comprises a historical collection of the temporarily stored data.

30. The method of claim 24, wherein the at least one predicted output is an indoor temperature of the enclosure, and wherein the temporarily stored data comprises measured indoor temperature.

31. A thermostat for use in an enclosure, comprising:
HVAC (heating, ventilation, and air conditioning) circuitry that controls HVAC states;
a temperature sensor that measures an indoor temperature of the enclosure;
control circuitry operative to:
receive an outdoor temperature;
access a thermodynamic state-space model engine that generates a predictive indoor temperature based, at least in part, on inputs that affect an internal temperature of the enclosure, at least one enclosure sensor reading, a current state-space model representation of the enclosure, and a correction factor that accounts for differences between the at least one predictive output and the at least one enclosure sensor reading, wherein the inputs comprise the HVAC states and the outdoor temperature, and wherein the at least one enclosure sensor reading comprises the indoor temperature.

32. The thermostat of claim 31, further comprising:
storage for temporarily storing samples of the HVAC states, outdoor temperature, and the indoor temperature taken during a sampling time period;
a database for storing a recursively updated history object comprising a historical collection of the HVAC states, outdoor temperature, and the indoor temperature sampled prior to a start of the sampling time period; and
wherein the control circuitry is operative to update the current state-space model representation of the enclosure based on the temporarily stored samples and the recursively updated history object.

33. The thermostat of claim 32, wherein the control circuitry is operative to:
update the recursively updated history object with the temporarily sampled data after an end of the sampling time period.

34. The thermostat of claim 32, wherein
the control circuitry is operative to access a mapping function determination engine to update the current state-space model representation of the enclosure.

35. The thermostat of claim 31, wherein the control circuitry is operative to adjust an order number of the state-space model.

36. A method for controlling a HVAC (heating, ventilation, and air conditioning) system, the method implemented in a thermostat, the method comprising:
defining a thermodynamic model that approximates thermal characteristics of an enclosure based on a set of inputs that affect thermal characteristics of the enclosure, a set of sensor readings that indicate observed thermal characteristics within the enclosure, and recursively updated history data;
using the thermodynamic model to predict a set of outputs associated with the enclosure in response to application of the set of inputs;
receiving an indication that a new sensor reading that indicates observed thermal characteristics within the enclosure is available; and
in response to the received indication, incorporating the new sensor reading into the set of sensor readings so that the thermodynamic model is updated to take the new sensor reading into account.

37. The method of claim 36, further comprising:
receiving an indication that a new input that affects thermal characteristics of the enclosure is available; and
in response to the received indication of the new input, incorporating the new input into the set of inputs so that the thermodynamic model is updated to take the new input into account.

38. The method of claim 36, wherein the thermodynamic model is the only model that approximates the thermal characteristics of the enclosure, and it remains the only model regardless of any changes to the set of inputs and the set of sensor readings.

39. The method of claim 36, wherein the recursively updated history data comprises the set of outputs, the set of inputs, and correction factors, wherein correction factors are determined based on comparisons between the set of outputs and the set of sensor readings.

40. The method of claim 39, wherein the recursively updated history data is updated only with newly acquired data.

41. The method of claim 1, wherein the thermodynamic model is a state-space model.

42.-59. (canceled)
